(19) United States
(12) Patent Application Publication
(10) Pub. No.: US 2024/0205391 A1
(43) Pub. Date: Jun. 20, 2024

(54) IMAGE DECODING DEVICE, IMAGE DECODING METHOD, AND PROGRAM

(71) Applicant: KDDI CORPORATION, Tokyo (JP)

(72) Inventors: Yoshitaka KIDANI, Fujimino-shi (JP); Kei KAWAMURA, Fujimino-shi (JP)

(73) Assignee: KDDI CORPORATION, Tokyo (JP)

(21) Appl. No.: 18/594,137

(22) Filed: Mar. 4, 2024

Related U.S. Application Data
(63) Continuation of application No. PCT/JP2022/030194, filed on Aug. 5, 2022.

(30) Foreign Application Priority Data
Sep. 27, 2021 (JP) 2021-157115

(51) Int. Cl. H04N 19/105; H04N 19/119; H04N 19/137; H04N 19/176; H04N 19/70

(52) U.S. Cl. CPC H04N 19/105; H04N 19/119; H04N 19/137; H04N 19/176; H04N 19/70

(57) ABSTRACT

An image decoding device according to the present invention includes a circuit, wherein the circuit: derives motion information for a geometric partitioning mode to generate a motion compensation sample; and derives an intra prediction mode for the geometric partitioning mode to generate an intra prediction sample, the circuit: derives a plurality of the intra prediction modes on the basis of adjacent reference samples or adjacent reference blocks adjacent to the block to be decoded, and selects, with use of a signaled index, one or a plurality of intra prediction modes from an intra prediction mode candidate list including the plurality of derived intra prediction modes to generate the intra prediction sample.

### CROSS-REFERENCE TO RELATED APPLICATIONS

The present application is a continuation of PCT Application No. PCT/JP2022/030194, filed on Aug. 5, 2022, which claims the benefit of Japanese patent application No. 2021-157115 filed on Sep. 27, 2021, the entire contents of which are incorporated herein by reference in its entirety.

### TECHNICAL FIELD

The present invention relates to an image decoding device, an image decoding method, and a program.

### BACKGROUND ART

Non Patent Literature 1 discloses a geometric partitioning mode (GPM).

The GPM diagonally divides a rectangular block into two and performs motion compensation on each of the two blocks. Specifically, in the GPM, each of the two partitioned areas is motion-compensated by a motion vector in a merge mode, and is blended by weighted averaging. As the oblique partitioning pattern, sixty-four patterns are prepared according to the angle and the displacement.

### CITATION LIST

### Non Patent Literature

Non Patent Literature 1: ITU-T H.266/VVC

Non-Patent Literature 2: JVET-W0024, “EE2: Summary Report on Enhanced Compression beyond VVC capability”

Non-Patent Literature 3: JVET-U0100, “Compression efficiency methods beyond VVC”

### SUMMARY OF THE INVENTION

However, since the GPM disclosed in Non Patent Literature 1 is limited to the inter prediction, there is a problem that there is room for improvement in coding performance.

Therefore, the present invention has been made in view of the above-described problems, and an object of the present invention is to provide an image decoding device, an image decoding method, and a program capable of improving inter prediction performance and improving coding performance when an intra prediction mode is added in a GPM.

A first feature of the present invention includes an inter prediction unit configured to derive motion information for a geometric partitioning mode to generate a motion compensation sample; an intra prediction unit configured to derive an intra prediction mode for the geometric partitioning mode to generate an intra prediction sample; and a prediction information buffer configured to store or output prediction information including the motion information or the intra prediction mode of a block to be decoded to which the geometric partitioning mode is applied, in which the intra prediction unit is configured to derive the intra prediction mode on the basis of an adjacent reference sample or an adjacent reference block adjacent to the block to be decoded, and generate an intra prediction sample using the derived intra prediction mode.

A second feature of the present invention is an image decoding device including: an inter prediction unit configured to derive motion information for a geometric partitioning mode to generate a motion compensation sample; an intra prediction unit configured to derive an intra prediction mode for the geometric partitioning mode to generate an intra prediction sample; and a prediction information buffer configured to store or output prediction information including the motion information or the intra prediction mode of a block to be decoded to which the geometric partitioning mode is applied, in which the intra prediction unit is configured to derive a plurality of the intra prediction modes on the basis of an adjacent reference sample or an adjacent reference block adjacent to the block to be decoded, and select, with use of a predetermined index, one or a plurality of intra prediction modes from an intra prediction mode candidate list including the plurality of derived intra prediction modes to control whether or not to generate the intra prediction sample.

A third feature of the present invention is an image decoding device including: an inter prediction unit configured to derive motion information for a geometric partitioning mode to generate a motion compensation sample; an intra prediction unit configured to derive an intra prediction mode for the geometric partitioning mode to generate an intra prediction sample; and a prediction information buffer configured to store or output prediction information including the motion information or the intra prediction mode of a block to be decoded to which the geometric partitioning mode is applied, in which the intra prediction unit is configured to derive a plurality of the intra prediction modes on the basis of a partitioned shape of the geometric partitioning mode or an adjacent reference sample or an adjacent reference block adjacent to the block to be decoded, and select, with use of a predetermined index, one or a plurality of intra prediction modes from an intra prediction mode candidate list including the plurality of derived intra prediction modes to control whether or not to generate the intra prediction sample, and register the intra prediction mode in a direction parallel to the partitioned shape of the geometric partitioning mode first in the intra prediction mode candidate list when deriving the plurality of intra prediction modes.

A fourth feature of the present invention is an image decoding device including a decoding unit configured to decode control data of a slice to be decoded or a block to be decoded, in which the decoding unit is configured to determine that a geometric partitioning mode for a chroma component block corresponding to a luminance component of the block to be decoded is not applicable even when it is determined that the geometric partitioning mode is applied to the luminance component of the block to be decoded in a case where the block to be decoded is included in an I slice and is identified as a Dual Tree by decoding the control data of the slice to be decoded or the block to be decoded, and not to determine that the geometric partitioning mode for the chroma component block is not applicable otherwise.

A fifth feature of the present invention is an image decoding device including: an intra prediction unit configured to derive an intra prediction mode for the geometric partitioning mode to generate an intra prediction sample; and a prediction information buffer configured to store or output prediction information including an intra prediction mode of a block to be decoded to which the geometric partitioning mode is applied and a prediction type capable of determining whether any one of inter prediction and intra prediction is applied, in which the intra prediction unit applies the geometric partitioning mode to a chroma component of the block to be decoded in a case where the block to be decoded is not a Dual Tree and the geometric partitioning mode is applied to a luminance component of the block to be decoded, and further derives an intra prediction mode used for each partitioned area by the geometric partitioning mode of a luminance component corresponding to a chroma component of the block to be decoded as an intra prediction mode for each partitioned area partitioned by the geometric partitioning mode of the chroma component.

A sixth feature of the present invention is an image decoding method including: deriving motion information for a geometric partitioning mode to generate a motion compensation sample; deriving an intra prediction mode for the geometric partitioning mode to generate an intra prediction sample, storing or outputting prediction information including the motion information or the intra prediction mode of a block to be decoded to which the geometric partitioning mode is applied, wherein the deriving of the intra prediction mode including: deriving a plurality of the intra prediction modes on the basis of an adjacent reference sample or an adjacent reference block adjacent to the block to be decoded, and selecting, with use of a predetermined index, one or a plurality of intra prediction modes from an intra prediction mode candidate list including the plurality of derived intra prediction modes to control whether or not to generate the intra prediction sample.

A seventh feature of the present invention is a program stored on a non-transitory computer-readable medium for causing a computer to function as an image decoding device including a circuit and a buffer: the circuit: derives motion information for a geometric partitioning mode to generate a motion compensation sample; and derives an intra prediction mode for the geometric partitioning mode to generate an intra prediction sample, the buffer stores or outputs prediction information including the motion information or the intra prediction mode of a block to be decoded to which the geometric partitioning mode is applied, the circuit: derives a plurality of the intra prediction modes on the basis of an adjacent reference sample or an adjacent reference block adjacent to the block to be decoded, and selects, with use of a predetermined index, one or a plurality of intra prediction modes from an intra prediction mode candidate list including the plurality of derived intra prediction modes to control whether or not to generate the intra prediction sample.

According to the present invention, it is possible to provide an image decoding device, an image decoding method, and a program capable of improving inter prediction performance and improving coding performance when an intra prediction mode is added in a GPM.

### BRIEF DESCRIPTION OF THE DRAWINGS

FIG. 1 is a diagram illustrating an example of a configuration of an image processing system 1 according to an embodiment.

FIG. 2 is a diagram illustrating an example of functional blocks of an image encoding device 100 according to an embodiment.

FIG. 3 is a diagram illustrating an example of functional blocks of an image decoding device 200 according to an embodiment.

FIG. 4 is a diagram illustrating an example of a case where a rectangular block to be decoded is partitioned into two areas of a partitioned area A and a partitioned area B of a geometric shape by a partition line of a geometric partitioning mode according to the geometric partitioning mode disclosed in Non-Patent Literature 1.

FIG. 5 illustrates an example of application of an intra prediction mode to a GPM according to the present embodiment.

FIG. 6 illustrates an example of application of an intra prediction mode to the GPM according to the present embodiment.

FIG. 7 is a diagram illustrating an example of an intra prediction mode candidate list according to the present embodiment.

FIG. 8 is a diagram illustrating an example of a method of deriving an intra prediction mode based on an adjacent reference sample with respect to normal intra prediction according to Non-Patent Literature 2, and a method 1 of deriving an intra prediction mode based on an adjacent reference sample with respect to a geometric partitioning mode according to the present embodiment to which the derivation method is applied.

FIG. 9 is a diagram illustrating a table for limiting an area of a template (adjacent reference sample) to be referred to on the basis of a partition line of a GPM in a technology called template matching for the GPM disclosed in Non-Patent Literature 2.

FIG. 10 is a diagram illustrating an example of a method of deriving an intra prediction mode based on an adjacent reference sample with respect to normal intra prediction according to Non-Patent Literature 3, and a method 2 of deriving an intra prediction mode based on an adjacent reference sample with respect to a geometric partitioning mode according to the present embodiment to which such a derivation method is applied.

FIG. 11 is a diagram illustrating an example of a method of deriving an intra prediction mode based on an adjacent reference block with respect to normal intra prediction according to Non-Patent Literature 1 and Non-Patent Literature 2, and a method of deriving an intra prediction mode based on an adjacent reference block with respect to a geometric partitioning mode according to the present embodiment to which such a derivation method is applied.

FIG. 12 is a diagram illustrating a method for building a merge candidate list disclosed in Non-Patent Literature 1.

FIG. 13 is a diagram illustrating an example of a value of a weighting coefficient w for a prediction sample of each partitioned area A/B of GPM according to Non-Patent Literature 1 and the present embodiment.

FIG. 14 is a diagram illustrating an example of angleIdx that defines an angle of a partition line of the GPM.

FIG. 15 is a diagram illustrating an example of disLut.

FIG. 16 is a diagram illustrating an example in which a stored prediction information type disclosed in Non-Patent Literature 1 and a stored prediction information type according to the present embodiment are specified for each 4×4 sample sub-block.

FIG. 17 is a diagram illustrating a list of motion information disclosed in Non-Patent Literature 1 and prediction information according to the present embodiment, which are stored according to a value of sType of sub-blocks configuring a GPM-applied block.

FIG. 18 is a diagram illustrating an example of prediction information stored in the GPM including two different inter predictions as illustrated in FIG. 4.

FIG. 19 is a diagram illustrating an example of the prediction information stored for a GPM including the intra prediction and the inter prediction in FIG. 5.

FIG. 20 is a diagram illustrating an example of the prediction information stored for the GPM including two different intra predictions as illustrated in FIG. 6.

FIG. 21 is a diagram illustrating an example of the prediction information stored for the GPM including two different intra predictions as illustrated in FIG. 7.

### DESCRIPTION OF EMBODIMENTS

An embodiment of the present invention will be described hereinbelow with reference to the drawings.

Note that the constituent elements of the embodiment below can, where appropriate, be substituted with existing constituent elements and the like, and that a wide range of variations, including combinations with other existing constituent elements, is possible. Therefore, there are no limitations placed on the content of the invention as in the claims on the basis of the disclosures of the embodiment hereinbelow.

### First Embodiment

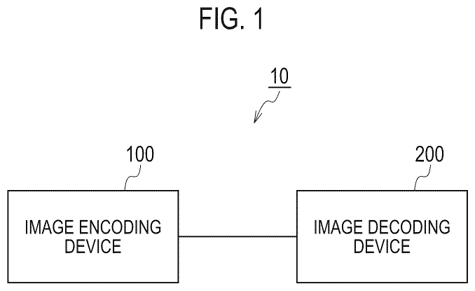

Hereinafter, an image processing system 10 according to a first embodiment of the present invention will be described with reference to FIGS. 1 to 21. FIG. 1 is a diagram illustrating the image processing system 10 according to the present embodiment.

### (Image Processing System 10)

As illustrated in FIG. 1, the image processing system 10 according to the present embodiment includes an image coding device 100 and an image decoding device 200. The image coding device 100 is configured to generate coded data by coding an input image signal (picture). The image decoding device 200 is configured to generate an output image signal by decoding the coded data.

The coded data may be transmitted from the image coding device 100 to the image decoding device 200 via a transmission path. The coded data may be stored in a storage medium and then provided from the image coding device 100 to the image decoding device 200.

### (Image Coding Device 100)

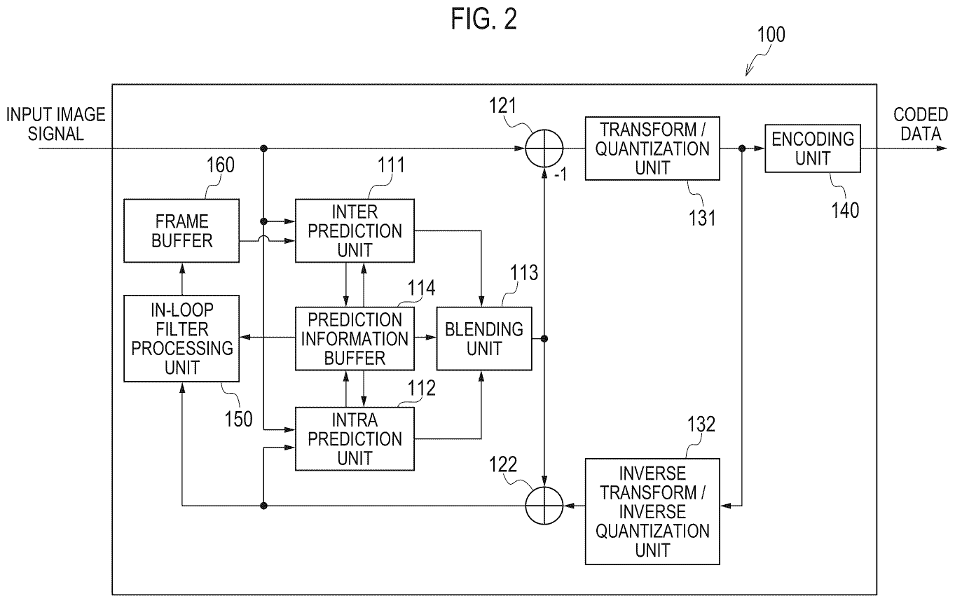

Hereinafter, the image coding device 100 according to the present embodiment will be described with reference to FIG. 2. FIG. 2 is a diagram illustrating an example of functional blocks of the image coding device 100 according to the present embodiment.

As shown in FIG. 2, the image coding device 100 includes an inter prediction unit 111, an intra prediction unit 112, a blending unit 113, a prediction information buffer 114, a subtractor 121, an adder 122, a transform/quantization unit 131, an inverse transform/inverse quantization unit 132, an encoding unit 140, an in-loop filtering processing unit 150, and a frame buffer 160.

The inter prediction unit 111 is configured to generate a prediction signal by inter prediction (inter-frame prediction).

Specifically, the inter prediction unit 111 is configured to specify a reference block included in a reference frame by comparing a frame to be decoded (hereinafter, referred to as a current frame) with the reference frame stored in the frame buffer 160, and determine a motion vector (mv) for the specified reference block. Here, the reference frame is a frame different from the current frame.

The inter prediction unit 111 is configured to generate the prediction signal included in a block to be decoded (hereinafter, referred to as a current block) for each current block based on the reference block and the motion vector.

The inter prediction unit 111 is configured to output the inter prediction signal to the blending unit 113.

Although not illustrated in FIG. 2, the inter prediction unit 111 is configured to output information related to inter prediction control (specifically, information such as an inter prediction mode, a motion vector, a reference frame list, and a reference frame number) to the encoding unit 140.

The intra prediction unit 112 is configured to generate a prediction signal by intra prediction (intra-frame prediction).

Specifically, the intra prediction unit 112 is configured to specify the reference block included in the current frame, and generate the prediction signal for each current block based on the specified reference block. Here, the reference block is a block referred to for the current block. For example, the reference block is a block adjacent to the current block.

Furthermore, the intra prediction unit 112 is configured to output the intra prediction signal to the blending unit 113.

Furthermore, although not illustrated in FIG. 2, the intra prediction unit 112 is configured to output information (specifically, information such as an intra prediction mode) regarding control of intra prediction to the encoding unit 140.

The blending unit 113 is configured to blend the inter prediction signal input from the inter prediction unit 111 and/or the intra prediction signal input from the intra prediction unit 112 using a preset weighting factor, and output the blended prediction signal (hereinafter, collectively referred to as a prediction signal) to the subtractor 121 and the adder 122.

The blending unit 113 is configured to blend the inter prediction signal input from the inter prediction unit 111 and/or the intra prediction signal input from the intra prediction unit 112 using a preset weighting factor, and output the blended prediction signal (hereinafter, collectively referred to as a prediction signal) to the subtractor 121 and the adder 122.

The prediction information buffer 114 is configured to store prediction information input from the inter prediction unit 111 or the intra prediction unit 112, or output the stored prediction information to the inter prediction unit 111, the intra prediction unit 112, the blending unit 113, or the in-loop filter processing unit 150. Here, details of the prediction information will be described later.

Here, regarding the blending processing of the inter prediction signal and/or the intra prediction signal by the blending unit 113, the same configuration as that of Non Patent Literature 1 can be adopted in the present embodiment, and thus the description thereof will be omitted.

The subtractor 121 is configured to subtract the prediction signal from the input image signal, and output a prediction residual signal to the transform/quantization unit 131. Here, the subtractor 121 is configured to generate the prediction residual signal that is a difference between the prediction signal generated by intra prediction or inter prediction and the input image signal.

The adder 122 is configured to add the prediction signal output from the blending unit 113 to the prediction residual signal output from the inverse transform/inverse quantization unit 132 to generate a decoded signal before filtering, and output the decoded signal before filtering to the intra prediction unit 112 and the in-loop filter processing unit 150.

Here, the pre-filtering decoded signal constitutes the reference block used by the intra prediction unit 112.

The transform/quantization unit 131 is configured to perform transform processing for the prediction residual signal and acquire a coefficient level value.

Furthermore, the transform/quantization unit 131 may be configured to perform quantization of the coefficient level value.

Here, the transform processing is transforming the prediction residual signal into a frequency component signal. In such transform processing, a kernel pattern (transformation matrix) corresponding to discrete cosine transform (Hereinafter referred to as DCT) may be used, or a kernel pattern (transformation matrix) corresponding to discrete sine transform (Hereinafter referred to as DST) may be used.

Furthermore, as the transform processing, multiple transform selection (MTS) that enables selection of a transform kernel suitable for deviation of the coefficient of the prediction residual signal from the plurality of transform kernels disclosed in Non Patent Literature 1 for each of the horizontal and vertical directions, or low frequency-non-separable transform (LENST) that improves the coding performance by further concentrating the transform coefficient after the primary transform in the low frequency area may be used.

The inverse transform/inverse quantization unit 132 is configured to perform inverse transform processing for the coefficient level value output from the transform/quantization unit 131. Here, the inverse transform/inverse quantization unit 132 may be configured to perform inverse quantization of the coefficient level value prior to the inverse transform processing.

Here, the inverse transform processing and the inverse quantization are performed in a reverse procedure to the transform processing and the quantization performed by the transform/quantization unit 131.

The encoding unit 140 is configured to code the coefficient level value output from the transform/quantization unit 131 and output coded data.

Here, for example, the coding is entropy coding in which codes of different lengths are assigned based on a probability of occurrence of the coefficient level value. Furthermore, the encoding unit 140 is configured to code control data used in decoding processing in addition to the coefficient level value.

Here, the control data may include information related to the block size (flag and index) such as a coding block size, a prediction block size, and a transform block size.

Furthermore, the control data may include information (flag and index) necessary for control of the inverse transform/inverse quantization processing of the inverse transform/inverse quantization unit 220, the inter prediction signal generation processing of the inter prediction unit 241, the intra prediction signal generation processing of the intra prediction unit 242, the blending processing of the inter prediction signal or/and the intra prediction signal of the blending unit 243, the filter processing of the in-loop filter processing unit 250, and the like in the image decoding device 200 described later.

Note that, in Non Patent Literature 1, these pieces of control data are referred to as syntaxes, and the definition thereof is referred to as semantics.

Furthermore, the control data may include header information such as a sequence parameter set (SPS), a picture parameter set (PPS), and a slice header as described later.

The in-loop filtering processing unit 150 is configured to execute filtering processing on the pre-filtering decoded signal output from the adder 122 and output the filtered decoded signal to the frame buffer 160.

Herein, for example, the filter processing is deblocking filter processing, which reduces the distortion generated at boundary parts of blocks (encoded blocks, prediction blocks, or transform blocks), or adaptive loop filter processing, which switches filters based on filter coefficients, filter selection information, local properties of picture patterns of an image, etc. transmitted from the image encoding device 100.

The frame buffer 160 is configured to accumulate the reference frames used by the inter prediction unit 111.

Here, the filtered decoded signal constitutes the reference frame used by the inter prediction unit 111.

### (Image Decoding Device 200)

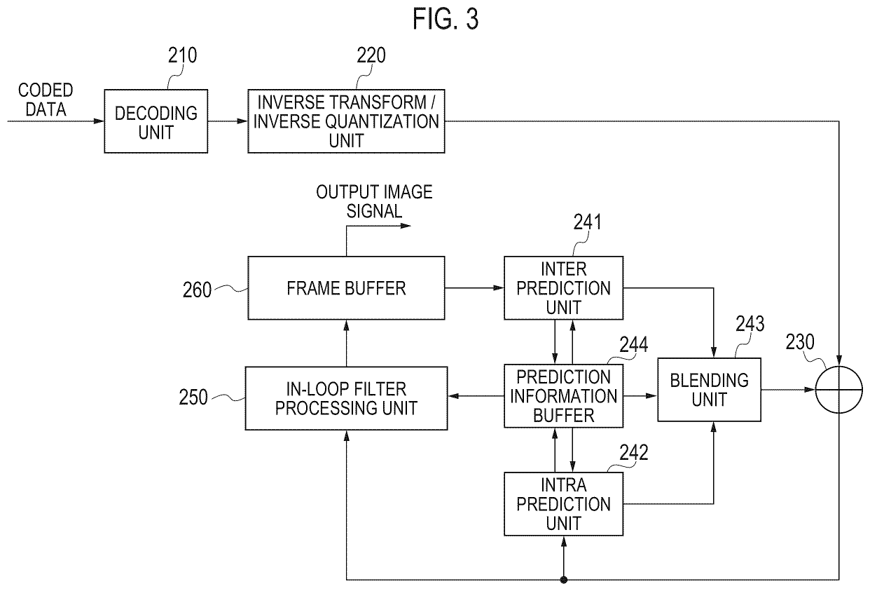

Hereinafter, the image decoding device 200 according to the present embodiment will be described with reference to FIG. 3. FIG. 3 is a diagram illustrating an example of functional blocks of the image decoding device 200 according to the present embodiment.

As illustrated in FIG. 3, the image decoding device 200 includes a decoding unit 210, an inverse transform/inverse quantization unit 220, an adder 230, an inter prediction unit 241, an intra prediction unit 242, a blending unit 243, a prediction information buffer 224, an in-loop filtering processing unit 250, and a frame buffer 260.

The decoding unit 210 is configured to decode the coded data generated by the image coding device 100 and decode the coefficient level value.

Here, the decoding is, for example, entropy decoding performed in a reverse procedure to the entropy coding performed by the encoding unit 140.

Furthermore, the decoding unit 210 may be configured to acquire control data by decoding processing for the coded data.

Here, the control data may include information related to the block size of the decoded block (synonymous with a block to be encoded in the above-described image encoding device 100, hereinafter, collectively referred to as a current block) described above.

Furthermore, the control data may include information (flag or index) necessary for control of the inverse transform/inverse quantization processing of the inverse transform/inverse quantization unit 220, the predicted sample generation processing of the inter prediction unit 241 or the intra prediction unit 242, the filter processing of the in-loop filter processing unit 250, and the like.

Furthermore, the control data may include header information such as a sequence parameter set (SPS), a picture parameter set (PPS), a picture header (PH), or a slice header (SH) described above.

The inverse transform/inverse quantization unit 220 is configured to perform inverse transform processing for the coefficient level value output from the decoding unit 210. Here, the inverse transform/inverse quantization unit 220 may be configured to perform inverse quantization of the coefficient level value prior to the inverse transform processing.

Here, the inverse transform processing and the inverse quantization are performed in a reverse procedure to the transform processing and the quantization performed by the transform/quantization unit 131.

Similarly to the inter prediction unit 111, the inter prediction unit 241 is configured to generate a prediction signal by inter prediction (inter-frame prediction).

Specifically, the inter prediction unit 241 is configured to generate the prediction signal for each prediction block based on the motion vector decoded from the coded data and the reference signal included in the reference frame. The inter prediction unit 241 is configured to output the prediction signal to the blending unit 243.

Similarly to the intra prediction unit 112, the intra prediction unit 242 is configured to generate a prediction signal by intra prediction (intra-frame prediction).

Specifically, the intra prediction unit 242 is configured to specify the reference block included in the current frame, and generate the prediction signal for each prediction block based on the specified reference block. The intra prediction unit 242 is configured to output the prediction signal to the blending unit 243.

Like the blending unit 113, the blending unit 243 is configured to blend the inter prediction signal input from the inter prediction unit 241 and/or the intra prediction signal input from the intra prediction unit 242 using a preset weighting factor, and output the blended prediction signal (hereinafter, collectively referred to as a prediction signal) to the adder 230.

Similarly to the prediction information buffer 114, the prediction information buffer 244 is configured to store prediction information input from the inter prediction unit 221 or the intra prediction unit 222, or output the stored prediction information to the inter prediction unit 241, the intra prediction unit 242, the blending unit 243, or the in-loop filter processing unit 250. Here, details of the prediction information will be described later.

The adder 230 is configured to add the prediction signal output from the blending unit 243 to the prediction residual signal output from the inverse transform/inverse quantization unit 220 to generate a pre-filtering decoded signal, and output the pre-filtering decoded signal to the in-loop filtering processing unit 250.

Here, the decoded signal before filtering configures a reference block used by the intra prediction unit 242.

Similarly to the in-loop filtering processing unit 150, the in-loop filtering processing unit 250 is configured to execute filtering processing on the pre-filtering decoded signal output from the adder 230 and output the filtered decoded signal to the frame buffer 260.

Herein, for example, the filter processing is deblocking filter processing, which reduces the distortion generated at boundary parts of blocks (coding blocks, prediction blocks, transform blocks, or sub-blocks obtained by dividing them), or adaptive loop filter processing, which switches filters based on filter coefficients, filter selection information, local properties of picture patterns of an image, etc. transmitted from the image encoding device 100.

Similarly to the frame buffer 160, the frame buffer 260 is configured to accumulate the reference frames used by the inter prediction unit 241.

Here, the filtered decoded signal constitutes the reference frame used by the inter prediction unit 241.

### (Geometric Partitioning Mode)

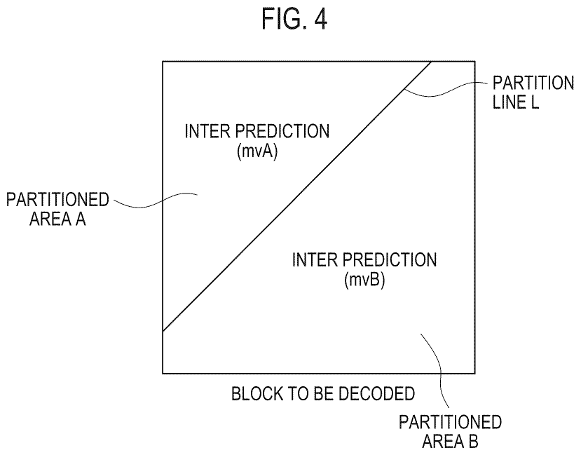

Hereinafter, with reference to FIG. 4, the geometric partitioning mode (GPM) disclosed in Non Patent Literature 1 related to the decoding unit 210, the inter prediction unit 241, and the intra prediction unit 242 will be described.

FIG. 4 illustrates an example of a case where a rectangular decoding current block is partitioned into two areas of partitioned area A and partitioned area B of a geometric shape by a partitioning line L1 of the geometric partitioning mode according to the geometric partitioning mode disclosed in Non Patent Literature 1.

Here, sixty-four patterns of the partitioning line L1 of the geometric partitioning mode disclosed in Non Patent Literature 1 are prepared according to the angle and the displacement.

Furthermore, the GPM according to Non Patent Literature 1 applies a normal merge mode, which is a type of inter prediction, to each of the partitioned area A and the partitioned area B to generate an inter predicted (motion-compensated) sample.

Specifically, in such a GPM, a merge candidate list disclosed in Non-Patent Literature 1 is built, a motion vector (mvA, mvB) and a reference frame of each partitioned area A/B are derived on the basis of the merge candidate list and two merge indexes (merge_gpm_idx0, merge_gpm_idx1) for each partitioned area A/B transmitted from the image encoding device 100, and a reference block, that is, an inter prediction (or motion compensation) block is generated. Finally, the inter prediction samples of each partitioned area A/B are weighted and averaged by a preset weight and blended.

(Application of intra prediction to GPM)

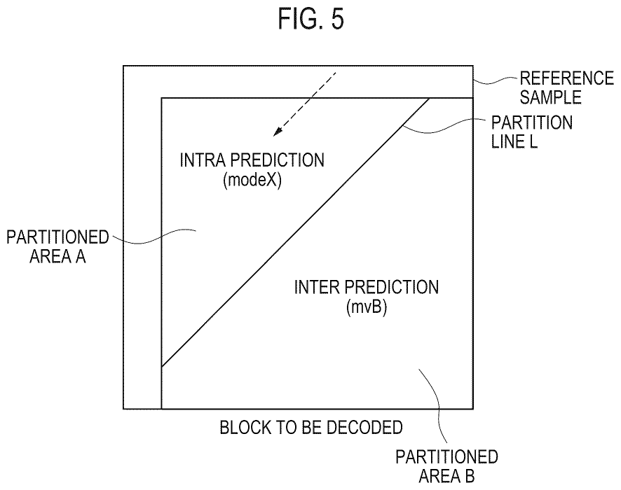

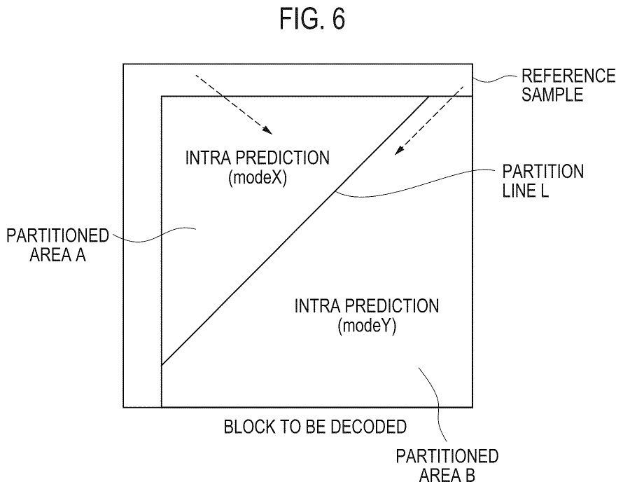

Hereinafter, application of the decoding unit 210, the inter prediction unit 241, and the intra prediction unit 242 to the geometric partitioning mode (GPM) disclosed in Non-Patent Literature 1 and the first geometric partitioning mode (GPM) according to the present embodiment will be described with reference to FIGS. 5 and 6.

FIGS. 5 and 6 illustrate an example of application of the intra prediction mode to the GPM according to the present embodiment.

Specifically, FIG. 5 illustrates a configuration example of the GPM in a case where the intra prediction (modeX) and the inter prediction are applied to each partitioned area A/B according to the present embodiment. FIG. 6 illustrates a configuration example of the GPM in a case where two different intra predictions (modeX, modeY) are applied to A/B of each partitioned area according to the present embodiment.

Here, in the first GPM according to the present embodiment, either the inter prediction mode or the intra prediction mode can be applied to each partitioned area A/B, and the type of the intra prediction mode is limited according to the partition shape (partition line) of the current block. Furthermore, the type of the intra prediction mode applied in the intra prediction is limited on the basis of the partitioned shape (partition line) of the GPM applied to the current block. That is, an applicable intra prediction mode is derived on the basis of the partitioned shape (partition line) of the GPM applied to the current block.

Furthermore, in the second GPM according to the present embodiment, a method of specifying the application possibility of the GPM to which the intra prediction mode is additionally applied in the block to be decoded and the prediction mode type in each of the partitioned areas A/B when the GPM is applied is defined.

Consequently, the GPM to which the intra prediction mode is additionally applied is appropriately applied to the block to be decoded, and the optimum prediction mode is specified, as a result of which the coding performance can be further improved.

Note that, hereinafter, GPMs configured by two different inter predictions as illustrated in FIG. 4, GPMs configured by intra prediction and inter prediction as illustrated in FIG. 5, and GPMs configured by two intra predictions as illustrated in FIG. 6 are referred to as Inter/Inter-GPM, Intra/Inter-GPM, and Intra/Intra-GPM, respectively.

Furthermore, in the present embodiment, for the intra prediction additionally applied to the GPM, the method of deriving the intra prediction mode based on the adjacent reference sample or the adjacent reference block adjacent to the block to be decoded is defined in addition to the method of deriving the intra prediction mode based on the partitioned shape (partition line) of the GPM applied to the block to be decoded described above.

Here, the adjacent reference sample or the adjacent reference block adjacent to the block to be decoded is a reference sample or a reference block that is adjacent to the block to be decoded and for which decoding processing has been completed at the start of decoding processing of the block to be decoded.

Since the intra prediction mode applied to the intra prediction of the GPM can be derived based on the adjacent reference sample or the adjacent reference block, the intra prediction performance in the GPM is improved, as a result which the room for further improvement in the coding performance can be realized.

### [Intra Prediction Mode Derivation Method and Selection Method in Intra Prediction Unit 242]

Hereinafter, a method of deriving and selecting an intra prediction mode for Intra/Inter-GPM and Intra/Intra-GPM among application patterns of intra prediction to the GPM proposed in the present embodiment in the intra prediction unit 242 will be described.

### (Intra Prediction Mode Candidate List)

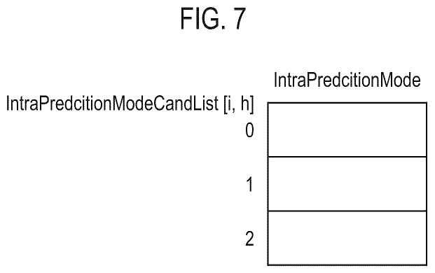

Hereinafter, a method of constructing an intra prediction mode candidate list (hereinafter, intra prediction mode candidate list) for the GPM in the intra prediction unit 242 according to the present embodiment will be described with reference to FIG. 7. FIG. 7 is a diagram illustrating an example of an intra prediction mode candidate list according to the present embodiment.

In the present embodiment, a list size of the intra prediction mode candidate list may be a fixed value. For example, the list size may be “3”, “4”, and “5”, “6” which is a maximum size of the intra prediction mode candidate list for the intra prediction block to which the GPM is not applied disclosed in Non-Patent Literature 1, or “22” which is the maximum size of the intra prediction mode candidate list for the intra prediction block to which the GPM is not applied disclosed in Non-Patent Literature 3. Alternatively, the list size may be a positive number between “7” and “21”.

Alternatively, the list size of the intra prediction mode candidate list may be a variable value. For example, an index defining the maximum value of the list size is included in the control data in units of sequence, picture, or slice, and the control data is decoded by the decoding unit 210, thereby making it possible to specify the maximum value of the list size in units of sequence, picture, or slice.

In the intra prediction mode candidate list, a plurality of intra prediction modes derived based on a partitioned shape of the GPM described later or an adjacent reference sample adjacent reference block adjacent to the block to be decoded are registered. Details of a method of deriving these intra prediction modes will be described later.

After the derivation of the intra prediction mode (construction of the intra prediction mode candidate list) is completed, the intra prediction unit may select any one intra prediction mode in the intra prediction mode candidate list for each of the partitioned areas A/B to be used for intra prediction sample generation on the basis of values of two intra prediction mode indexes (intra_gpm_idx0 and intra_gpm_idx1) for each of the partitioned areas A/B decoded or estimated by the decoding unit 210.

Note that, in a case where the two intra prediction mode indexes have the same value with respect to the Intra/Intra-GPM, the GPM is the same as the non-applied intra prediction, and thus, the two intra prediction mode indexes are configured to always have different values.

Furthermore, as a modification, in the derivation of the intra prediction mode for the partitioned area A/B of the Intra/Intra-GPM, instead of the intra prediction mode candidate list commonly used for the partitioned area A/B described above, different intra prediction mode candidate lists may be constructed for the partitioned area A/B, and the intra prediction modes for the partitioned area A/B may be derived from the respective intra prediction mode candidate lists and the respective intra prediction mode indexes for the partitioned area A/B.

The method of constructing the two different intra prediction mode candidate lists may be controlled by the partitioned shape of the GPM.

For example, in a method of deriving the intra prediction mode on the basis of a GPM partitioned shape to be described later, in a case where there are a partitioned area including a sample located at an uppermost left of a block to be decoded and a partitioned area not including a sample located at the uppermost left, Angular prediction or Angular prediction or Plnar prediction close to the perpendicular direction with respect to the GPM partition line can be registers in the intra prediction mode candidate list for the former partitioned area, but Angular prediction in the perpendicular direction or Angular prediction or Plnar prediction close to the perpendicular direction with respect to the GPM partition line or the DC prediction may not be registered in the intra prediction mode candidate list for the latter partitioned area.

At this time, the Angular prediction or the Angular prediction or the Plnar prediction close to the perpendicular direction with respect to the partition line of the GPM registered in the intra prediction mode candidate list for the former partitioned area may be registered to the minimum list number of the intra prediction mode candidate list or the next list number thereof.

Alternatively, the Angular prediction in the direction parallel to the GPM partition line may not be registered in the intra prediction mode candidate list for the former partitioned area, and the Angular prediction in the direction parallel to the GPM partition line may be registered in the intra prediction mode candidate list for the latter partitioned area.

At this time, the Angular prediction in the direction parallel to the partition line of the GPM registered in the intra prediction mode candidate list for the latter partitioned area may be registered in the minimum list number of the intra prediction mode candidate list.

With the above configuration, the latter partitioned area can avoid predicting adjacent reference samples adjacent to the block to be decoded while crossing the former partitioned area, that is, avoiding Angular prediction in the perpendicular direction or Angular prediction, Plnar prediction, or DC prediction near the perpendicular direction with respect to the GPM partition line, and the latter partitioned area can predict adjacent reference samples adjacent to the block to be decoded without crossing the former partitioned area, that is, Angular prediction in the parallel direction with respect to the GPM partitioned line, so that the effect of improving the prediction performance can be expected.

For the two different intra prediction mode candidate lists, a method of deriving the intra prediction mode based on the adjacent reference sample or the adjacent reference block adjacent to the block to be decoded described later may be partially changed.

For example, the intra prediction mode candidates derived from each of the intra prediction mode candidate lists may be registered using only adjacent reference samples or adjacent reference blocks adjacent to each of the partitioned areas according to the partitioned shape of the GPM.

Note that the decoding unit 210 may determine whether or not it is necessary to decode an intra prediction mode index for selecting an intra prediction mode to be used for generating an intra prediction sample from the intra prediction mode candidate list according to the total number of applications of intra predictions configuring the GPM.

Here, as the above-described modification, the intra prediction unit 242 may select a plurality of intra prediction modes in the intra prediction mode candidate list according to a value of the above-described intra prediction mode index, and generate an intra prediction sample.

According to such a configuration, in the hardware-implemented image decoding device 200, a circuit scale required for generating the intra prediction sample increases, but since the intra prediction sample can be generated by a plurality of intra prediction modes, the intra prediction performance is improved, as a result of which improvement in the coding performance can be expected.

In the case that the intra prediction sample is generated (blended) using the plurality of intra prediction modes, the intra prediction sample may be blended on average.

Alternatively, the intra prediction samples may be blended by performing weighted averaging with a predetermined weight value. For example, as a method of setting such a predetermined weight value, the weight value may be set to be larger for an intra prediction mode in which a registration order of the intra prediction mode candidate list is earlier (list number is smaller). On the other hand, the weight value may be set to be smaller as the registration order of the intra prediction mode candidate list is slower (the list number is larger).

Since the intra prediction mode having a smaller intra prediction mode candidate list number has a higher improvement rate of the intra prediction performance applied to the GPM, as a result, an improvement effect of the coding performance can be expected by setting the intra prediction mode candidate list number in this manner.

### (Method for Deriving Intra Prediction Mode Based on Partitioned Shape)

In the present embodiment, the intra prediction unit 242 derives the intra prediction mode on the basis of the partitioned shape (partition line) of the GPM and registers the intra prediction mode in the intra prediction mode candidate list described above.

Here, the derived intra prediction mode may be configured to be Angular prediction parallel to the GPM partitioned shape (partition line) from among 67 kinds of Angular predictions prepared for intra prediction (hereinafter, normal intra prediction) to which the GPM disclosed in Non-Patent Literature 1 is not applied, for example.

Alternatively, the intra prediction mode derived as a modification may be configured to be the Angular prediction perpendicular to the GPM partitioned shape (partition line) among the 67 kinds of Angular predictions prepared for the normal intra prediction disclosed in Non-Patent Literature 1.

The intra prediction unit 242 may register the derived Angular prediction at the beginning of the above-described intra prediction mode candidate list even after completion of derivation of another intra prediction mode to be described later.

In the intra prediction mode derived based on the partitioned shape of the GPM, the intra prediction sample can be generated while reflecting a texture of an edge or the like according to the partitioned shape of the GPM, so that the effect of improving the intra prediction performance can be expected. Therefore, since a selection rate of the intra prediction mode for the intra prediction area of the GPM can be expected to be high, a total code length of the necessary intra prediction mode index can be shortened if the intra prediction mode is associated with the minimum list number in the intra prediction mode candidate list, as a result of which an effect of improving the coding performance can be expected.

### (Intra Prediction Mode Derivation Method 1 Based on Adjacent Reference Sample)

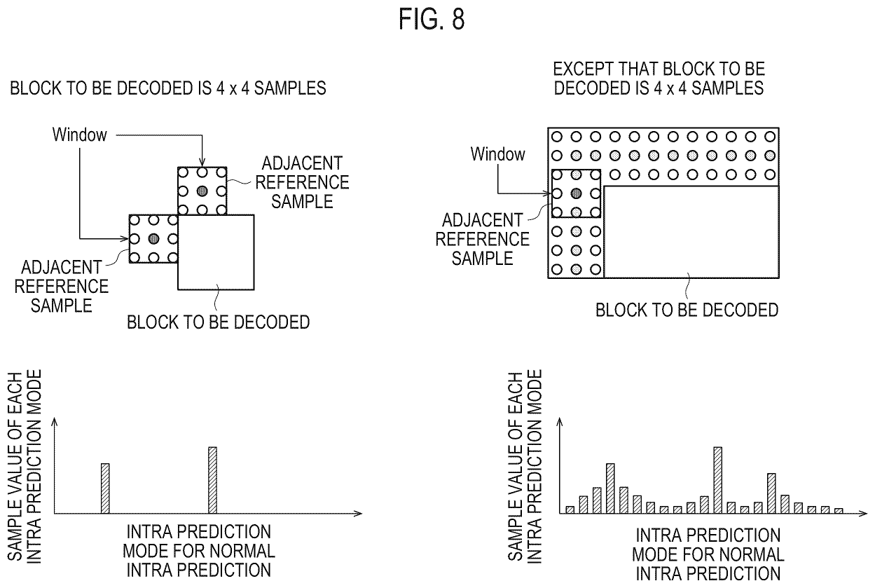

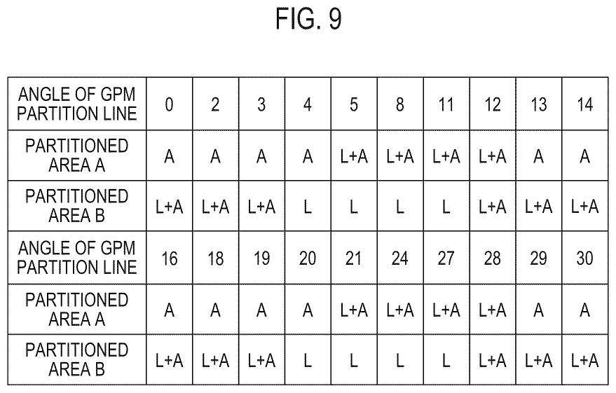

Hereinafter, a method of deriving an intra prediction mode based on an adjacent reference sample with respect to normal intra prediction according to Non-Patent Literature 2, and a method 1 of deriving an intra prediction mode based on an adjacent reference sample with respect to a geometric partitioning mode according to the present embodiment to which the derivation method is applied with reference to FIGS. 8 and 9.

FIG. 8 is a diagram illustrating an example of a method of deriving an intra prediction mode based on an adjacent reference sample with respect to normal intra prediction according to Non-Patent Literature 2, and a method 1 of deriving an intra prediction mode based on an adjacent reference sample with respect to a geometric partitioning mode according to the present embodiment to which such a derivation method is applied. Hereinafter, these derivation methods are collectively referred to as “DIMD (Decoder-side Intra Mode Derivation)”.

In Non-Patent Literature 2, in the DIMD, as illustrated in FIG. 8, horizontal and vertical Sobel filters of a window size of 3×3 samples are applied to the adjacent reference samples adjacent to the block to be decoded, and a histogram of sample values for all Angular prediction modes for the normal intra prediction is calculated. Here, a detailed description of the method of calculating the angle and the sample value of the adjacent reference sample to be associated with each Angular prediction mode by applying the Sobel filters will be omitted because the same configuration as that of Non-Patent Literature 2 can be adopted in the present embodiment.

In Non-Patent Literature 2, the adjacent reference sample area used for calculation of the histogram is controlled as illustrated in FIG. 8 according to a block size of the block to be decoded. Specifically, in the 4×4 sample block, the histogram is calculated by using only the upper and left 3×3 sample areas of the uppermost and leftmost samples of the block to be decoded.

In Non-Patent Literature 2, intra prediction samples are generated using the intra prediction mode and the planar mode that are the highest and second highest sample values in the calculated histogram, and further, the generated intra prediction samples are weighted and averaged using a predetermined weight value to generate a final intra prediction sample.

In the present embodiment, the intra prediction unit 242 may apply the DIMD disclosed in Non-Patent Literature 2 described above only to the derivation of the intra prediction mode of the GPM. That is, the process of blending/generating the intra prediction sample using the plurality of derived intra prediction modes is not performed.

As a result, intra prediction samples can be generated in one intra prediction mode in the intra prediction area (in the case of the Intra/Intra-GPM, two intra prediction areas) of the GPM. This makes it possible to apply intra prediction reflecting a texture such as an edge suitable for the partitioned shape of the GPM by analyzing the histogram of the adjacent reference sample of the block to be decoded while avoiding an increase in circuit scale necessary for generating the intra prediction sample of the GPM in the hardware-implemented image decoding device 200. Therefore, intra prediction performance is improved, as a result of which improvement in coding performance can be expected.

Note that, in the present embodiment, similarly to Non-Patent Literature 2, the decoding unit 210 may be configured to determine whether or not to derive the intra prediction mode by decoding or estimating a flag for determining whether or not the DIMD is applicable.

Furthermore, the intra prediction unit 242 according to the present embodiment may be configured to register the intra prediction mode derived by the DIMD in a case where the same intra prediction mode has not been already included in the intra prediction mode candidate list for the GPM, and not to register the intra prediction mode derived by the DIMD in a case where the same intra prediction mode has been already included in the intra prediction mode candidate list for GPM.

According to such a configuration, the same intra prediction mode can be prevented from being redundantly registered in the intra prediction mode candidate list.

Here, when a new intra prediction mode is registered in the intra prediction mode candidate list, consistency with the existing intra prediction mode is compared, and if both match, the process of pruning is hereinafter referred to as “intra prediction mode candidate selection processing”.

Furthermore, the intra prediction unit 242 according to the present embodiment may limit the number of intra prediction modes to be registered in the intra prediction mode candidate list to one among the intra prediction modes derived by the DIMD. In this case, the intra prediction unit 242 derives the Angular prediction mode that is the highest sample value (luminance value) from the histogram.

In the intra prediction mode candidate selection processing described above, in a case where the Angular prediction mode (hereinafter, 1st Angular prediction mode) that is the highest sample value (luminance value) is pruned, the 1st Angular prediction mode may be sequentially compared with the existing intra prediction modes from the higher histogram, and the intra prediction mode that do not match the existing intra prediction mode may be registered.

Alternatively, in a case where the 1st Angular prediction mode is pruned in the intra prediction mode candidate selection processing described above, the intra prediction mode derivation processing by the DIMD may be ended.

As a modification, the number of intra prediction modes to be registered in the intra prediction mode candidate list among the intra prediction modes derived by the DIMD may be limited to two. In such a case, the intra prediction unit 242 derives the 1st Angular prediction mode and the 2nd Angular prediction mode that is a second highest sample value (luminance value) from the histogram.

In a case where the 1st Angular prediction mode or the 2nd Angular prediction mode is pruned, similarly to the above case, the 1st or 2nd Angular prediction mode may be compared with the existing intra prediction modes from the next highest histogram, and the prediction mode that does not match the existing intra prediction mode may be registered, or the intra prediction mode deriving processing the by DIMD may be ended as it is.

Furthermore, the intra prediction unit 242 according to the present embodiment may limit the adjacent reference samples to be used in the above-described DIMD histogram calculation to a predetermined area on the basis of the GPM partitioned shape (that is, an angle of the GPM partition line).

FIG. 9 is a diagram illustrating a table for limiting an area of a template (adjacent reference sample) to be referred to on the basis of an angle (specifically, an index indicating an angle, angleIdx) of a partition line of the GPM in a technology called template matching for the GPM disclosed in Non-Patent Literature 2.

Specifically, A and L illustrated in FIG. 9 indicate an upper portion and a left portion of the block to be decoded, respectively.

In the present embodiment, the table of the adjacent reference samples defined (limited) based on the partition line of the GPM disclosed in Non-Patent Literature 2 may be applied to the calculation of the histogram of the DIMD. For example, in a case where the partitioned shape (angleIdx) of the geometric partitioning mode is “0”, the partitioned area A calculates a histogram by using the adjacent reference samples adjacent only to the upper part of the block to be decoded, while the partitioned area B calculates a histogram by using the adjacent reference samples adjacent to the upper part and the left part of the block to be decoded. The restriction of the reference position of the adjacent reference sample in the calculation of the histogram of the DIMD based on the partitioned shape of the geometric partitioning mode allows the Angular prediction to be derived using the adjacent reference sample existing only in the direction of the partition line of the GPM while avoiding using all the adjacent reference samples adjacent to the block to be decoded for the calculation, so that the processing load of deriving the intra prediction mode by the DIMD for the inter prediction of the GPM can be reduced.

### (Intra Prediction Mode Derivation Method 2 Based on Adjacent Reference Sample)

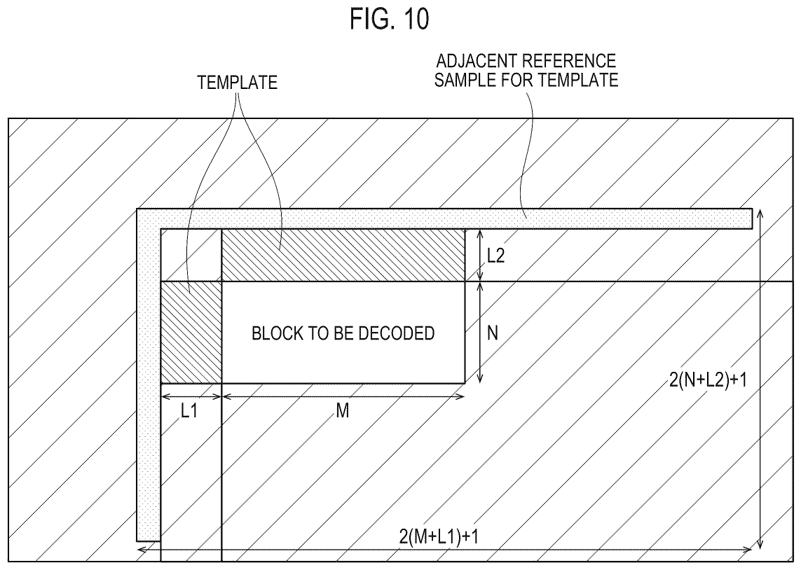

Hereinafter, a method of deriving an intra prediction mode based on an adjacent reference sample with respect to normal intra prediction according to Non-Patent Literature 3, and a method 2 of deriving an intra prediction mode based on an adjacent reference sample with respect to a geometric partitioning mode according to the present embodiment to which the derivation method is applied with reference to FIGS. 9 and 10.

FIG. 10 is a diagram illustrating an example of a method of deriving an intra prediction mode based on an adjacent reference sample with respect to normal intra prediction according to Non-Patent Literature 3, and a method 2 of deriving an intra prediction mode based on an adjacent reference sample with respect to a geometric partitioning mode according to the present embodiment to which such a derivation method is applied. Hereinafter, these derivation methods are collectively referred to as “Template-based Intra Mode Derivation (TIMD)”.

In Non-Patent Literature 3, in the TIMD, as illustrated in FIG. 10, a sum of absolute transformed difference (SATD) of adjacent reference samples (hereinafter, a template) of a predetermined line adjacent to the block to be decoded, adjacent reference samples for the template and intra prediction sample for the template (hereinafter, intra prediction samples for the template) generated using a predetermined intra prediction mode is calculated, and an intra prediction mode in which the SATD is minimum and the next highest among the predetermined intra prediction modes is derived as the intra prediction mode of the TIMD to generate an intra prediction sample.

Here, the intra prediction mode used in the calculation of the SATD of the TIMD described above is the intra prediction mode included in the intra prediction mode candidate list for the normal intra prediction.

In the TIMD in Non-Patent Literature 3, in a case where a vertical prediction mode, a horizontal prediction mode, and a DC prediction mode are not included in the intra prediction mode candidate list for the normal intra prediction, the SATD is calculated to derive the intra prediction mode in a state where those modes are included.

In the present embodiment, the intra prediction unit 242 may derive the intra prediction mode by applying the TIMD disclosed in Non-Patent Literature 3. That is, the intra prediction unit 242 does not perform the intra prediction sample combination/generation processing using the plurality of derived intra prediction modes.

According to the above configuration, the intra prediction samples can be generated in one intra prediction mode in the intra prediction area (in the case of the Intra/Intra-GPM, two intra prediction areas) of the GPM. This makes it possible to apply intra prediction reflecting a texture such as an edge suitable for the partitioned shape of the GPM by analyzing the histogram of the adjacent reference sample of the block to be decoded while avoiding an increase in circuit scale necessary for generating the intra prediction sample of the GPM in the hardware-implemented image decoding device 200. Therefore, intra prediction performance is improved, as a result of which improvement in coding performance can be expected.

Note that, in the present embodiment, similarly to Non-Patent Literature 2, the decoding unit 210 may be configured to determine whether or not to derive the intra prediction mode by decoding or estimating a flag for determining whether or not the TIMD is applicable.

Furthermore, the intra prediction unit 242 according to the present embodiment may be configured to register the intra prediction mode derived by the TIMD in a case where the same intra prediction mode has not been already included in the intra prediction mode candidate list for the GPM, and not to register the intra prediction mode derived by the TIMD in a case where the same intra prediction mode has been already included in the intra prediction mode candidate list for GPM.

According to such a configuration, the same intra prediction mode can be prevented from being redundantly registered in the intra prediction mode candidate list.

Here, when a new intra prediction mode is registered in the intra prediction mode candidate list, consistency with the existing intra prediction modes is compared, and if both match, the process of pruning is hereinafter referred to as “intra prediction mode candidate selection processing”.

Furthermore, the intra prediction unit 242 according to the present embodiment may limit the number of intra prediction modes to be registered in the intra prediction mode candidate list to one among the intra prediction modes derived by the TIMD. In such a case, the intra prediction unit 242 derives the intra prediction mode (Angular prediction) that is the minimum SATD cost from the calculation of the SATD.

However, in the present embodiment, in the calculation of the SATD in the TIMD processing, the DC prediction mode may be excluded from the calculation of the SATD, unlike Non-Patent Literature 3.

This is because the DC prediction in which the intra prediction sample is generated using all the adjacent reference samples adjacent to the block to be decoded cannot appropriately reflect the texture such as the edge according to the partitioned shape of the GPM, and the intra prediction sample may be generated. Therefore, with exclusion of the DC prediction from the calculation of the SATD in the TIMD processing, the DC prediction mode can be avoided from being derived in the TIMD.

Note that, in the intra prediction mode candidate selection processing described above, in a case where the Angular prediction mode (hereinafter, the 1st Angular prediction mode), which is the minimum SATD cost, is pruned, the 1st Angular prediction mode may be sequentially compared with the existing intra prediction modes in ascending order of the SATD cost, and the prediction mode that do not match the existing intra prediction mode may be registered. Alternatively, in a case where the 1st Angular prediction mode is pruned, the process of deriving the intra prediction mode by the TIMD may be ended.

As a modification, the number of intra prediction modes to be registered in the intra prediction mode candidate list among the intra prediction modes derived by the TIMD may be limited to two. In such a case, the intra prediction unit 242 derives the 1st Angular prediction mode and the 2nd Angular prediction mode, which is the second minimum one of the minimum SATD cost, from the SATD cost.

Note that, in a case where the 1st Angular prediction mode or the 2nd Angular prediction mode is pruned, similarly to the above case, the 1st or 2nd Angular prediction mode may be compared with the existing intra prediction modes from the next lowest SATD cost, and the prediction mode which does not match the existing intra prediction mode may be registered, or the process of deriving the intra prediction mode by the TIMD may be ended as it is.

Furthermore, the intra prediction unit 242 according to the present embodiment may limit the adjacent reference samples to be used in the calculation of the SATD cost of the TIMD described above to a predetermined area on the basis of the partitioned shape of the GPM (that is, the angle of the partition line of the GPM).

In the present embodiment, a table of the adjacent reference sample areas defined on the basis of the partition line of the GPM disclosed in Non-Patent Literature 2 illustrated in FIG. 9 may be applied to calculation of the SATD cost in the TIMD processing. For example, when the partitioned shape (angleIdx) of the geometric partitioning mode is “0”, the partitioned area A calculates the SATD cost using only the adjacent reference samples adjacent to only the upper portion of the block to be decoded and the adjacent reference samples adjacent to the upper portion of the adjacent reference samples, while the partitioned area B calculates the SATD cost using the adjacent reference samples adjacent to the upper portion and the left portion of the block to be decoded and the adjacent reference samples adjacent thereto. The restriction of the reference position of the adjacent reference sample in the calculation of the SATD cost in the TIMD processing, based on the partitioned shape of the geometric partitioning mode allows the Angular prediction to be derived using the adjacent reference sample existing only in the direction of the partition line of the GPM while avoiding using all the adjacent reference samples adjacent to the block to be decoded for the calculation, so that the processing load of deriving the intra prediction mode by the TIMD for the inter prediction of the GPM can be reduced.

Furthermore, in a case where the same intra prediction mode as the intra prediction mode used for calculation of the SATD in the TIMD processing has already been registered in the intra prediction mode candidate list, the intra prediction unit 242 according to the present embodiment may be configured not to perform the processing after the calculation of the SATD of the above intra prediction mode.

According to such a configuration, the same intra prediction mode can be avoided from being redundantly registered through the TIMD processing with respect to the intra prediction mode already registered in the intra prediction mode, thereby making it possible to reduce the load of the TIMD processing on the inter prediction of the GPM.

### (Intra Prediction Mode Derivation Method Based on Adjacent Reference Block)

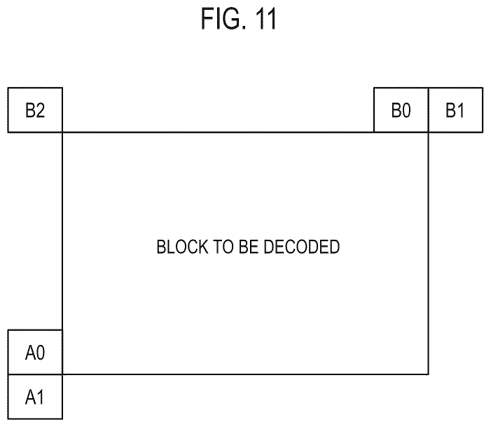

Hereinafter, a description will be given of a method of deriving an intra prediction mode based on an adjacent reference block with respect to normal intra prediction according to Non-Patent Literature 1 and Non-Patent Literature 2, and a method of deriving an intra prediction mode based on an adjacent reference block with respect to a geometric partitioning mode according to the present embodiment to which such a derivation method is applied with reference to FIGS. 9 and 11.

FIG. 11 is a diagram illustrating an example of a method of deriving an intra prediction mode based on an adjacent reference block with respect to normal intra prediction according to Non-Patent Literature 1 and Non-Patent Literature 2, and a method of deriving an intra prediction mode based on an adjacent reference block with respect to a geometric partitioning mode according to the present embodiment to which such a derivation method is applied. Hereinafter, these derivation methods are collectively referred to as “Block-based Intra Mode Derivation (BIMD)”.

In Non-Patent Literature 3, in the BIMD, as illustrated in FIG. 11, an intra prediction mode of an adjacent reference block at a predetermined position adjacent to a block to be decoded is derived as an intra prediction mode of the BIMD to generate an intra prediction sample.

Note that, as the intra prediction mode of the adjacent reference block derived here, in a case where the adjacent reference block is an intra prediction block, the intra prediction mode included in the adjacent reference block is referred to as it is. However, in a case where the adjacent reference block is an inter prediction block or a GPM-applied block to which an inter prediction block and an intra prediction are applied, an intra prediction mode stored in units of 4×4 sub-block samples to be described later is referred to.

Here, in Non-Patent Literature 1 and Non-Patent Literature 2, the adjacent reference blocks referred to in the above-described BIMD are set to the left (A0), the lower left (A1), the upper (B0), the upper right (B1), and the upper left (B2) of the block to be decoded as illustrated in FIG. 11.

In the present embodiment, the intra prediction unit 242 may derive the intra prediction mode by applying the BIMD disclosed in Non-Patent Literatures 1 and 2. That is, the intra prediction unit 242 does not perform the intra prediction sample combination/generation processing using the plurality of derived intra prediction modes.

According to such a configuration, the intra prediction mode can be selected from the intra prediction mode candidate list in which the intra prediction mode of the adjacent reference block of the block to be decoded can be included with respect to the intra prediction area (in the case of Intra/Intra-GPM, two intra prediction areas) of the GPM to generate the intra prediction sample. Therefore, the intra prediction reflecting the texture such as the edge suitable for the partitioned shape of the GPM can be applied, and the intra prediction performance is improved, as a result of which the improvement of the coding performance can be expected.

Furthermore, the intra prediction unit 242 according to the present embodiment may be configured to register the intra prediction mode derived by the BIMD in a case where the same intra prediction mode has not been already included in the intra prediction mode candidate list for the GPM, and not to register the intra prediction mode derived by the BIMD in a case where the same intra prediction mode has been already included in the intra prediction mode candidate list for GPM.

According to such a configuration, the same intra prediction mode can be prevented from being redundantly registered in the intra prediction mode candidate list.

Here, when a new intra prediction mode is registered in the intra prediction mode candidate list, consistency with the existing intra prediction mode is compared, and the pruning process in the case where both match is hereinafter referred to as “intra prediction mode candidate selection processing”.

Furthermore, unlike Non-Patent Literature 1 and Non-Patent Literature 2, the intra prediction unit 242 according to the present embodiment may be configured not to register a DC prediction mode in the intra prediction mode candidate list in a case where the intra prediction mode derived by the BIMD is the DC prediction mode.

This is because the DC prediction in which the intra prediction sample is generated using all the adjacent reference samples adjacent to the block to be decoded cannot appropriately reflect the texture such as the edge according to the partitioned shape of the GPM, and the intra prediction sample may be generated. Therefore, the DC prediction is excluded from the intra prediction mode of the BIMD, and the DC prediction mode can be avoided from being used to generate the intra prediction sample.

Furthermore, the intra prediction unit 242 according to the present embodiment may configure the order of up to five adjacent reference blocks illustrated in FIG. 11 to be referred to in deriving the intra prediction mode by the BIMD, similarly to Non-Patent Literature 1 and Non-Patent Literature 2. Note that, since the order of reference is disclosed in Non-Patent Literature 1 and Non-Patent Literature 2, a detailed description thereof is omitted in the present embodiment.

As a modification, in the present embodiment, a table of (limited) adjacent reference sample areas defined on the basis of the partition line of the GPM disclosed in Non-Patent Literature 2 illustrated in FIG. 9 may be applied to the reference to the adjacent reference block of the BIMD. For example, when the partitioned shape (angleIdx) of the geometric partitioning mode is “0”, the partitioned area A refers to the intra prediction mode of only the adjacent reference block (B0, B1, and B2 in FIG. 11) adjacent only to the upper portion of the block to be decoded, while the partitioned area B refers to the intra prediction mode of the adjacent reference block (left portion is A0, A1, and upper portion is B0, B1, B2) adjacent to the upper portion and the left portion of the block to be decoded. Due to the limitation of a reference position of the adjacent reference block in the derivation of the intra prediction mode of the BIMD based on the partitioned shape of the geometric partitioning mode, the intra prediction mode can be derived by referring only to the intra prediction mode (Angular prediction) of the adjacent reference block existing only in the direction of the partition line of the GPM while avoiding referring to the intra prediction modes of all the adjacent reference blocks adjacent to the block to be decoded, so that the load of the derivation processing of the intra prediction mode by the BIMD for the inter prediction of the GPM can be reduced.

### (Intra Prediction Mode Derivation Order)

The intra prediction unit 242 according to the present embodiment may be configured to derive an intra prediction mode by combining an intra prediction mode (hereinafter, GIMD: GPM-angle-based Intra Mode Derivation) based on the above-described GPM partitioned shape and a method of deriving three types of intra prediction modes (DIMD, TIMD, BIMD) based on adjacent reference samples or adjacent reference blocks. Hereinafter, a configuration example considered to be effective will be described.

Configuration example 1. GIMD→DIMD
Configuration example 2. GIMD→TIMD
Configuration example 3. GIMD→BIMD
Configuration example 4. GIMD→DIMD→TIMD
Configuration example 5. GIMD→DIMD→BIMD
Configuration example 6. GIMD→TIMD→BIMD

### 7. GIMD→DIMD→TIMD→BIMD

First, the configuration examples 1 to 3 are a method in which each of the DIMD, the TIMD, and the BIMD are combined with the GIMD. The intra prediction mode derived by the GIMD is configured to be derived before the DIMD, the TIMD, and the BIMD because there is a possibility that the intra prediction mode reflecting a texture such as an edge based on the partition line of the GPM can be derived more directly than the intra prediction mode derived by the DIMD, the TIMD, and the BIMD.

Next, the configuration examples 4 and 5 are configuration examples in which the DIMD is arranged before the TIMD or the BIMD.

The reason for placing the DIMD before the TIMD is that the derivation processing of the intra prediction mode by the DIMD is lighter than the derivation of the intra prediction mode by the TIMD in which relatively heavy calculation processing such as calculation of the SATD is included.

On the other hand, the reason why the DIMD is arranged before the BIMD is that the derivation processing of the intra prediction mode by the DIMD including the calculation of the histogram is not lighter than the derivation of the intra prediction mode by the BIMD, but the intra prediction mode derived by the DIMD may be able to derive the intra prediction mode reflecting the texture such as the edge based on the partition line of the GPM more by the calculation of the histogram than the intra prediction derived by the BIMD, and thus the effect of improving the intra prediction performance is considered to be high.

In the configuration example 6, the TIMD is arranged before the BIMD. The reason for the arrangement is the same as the reason for arranging the DIMD before the BIMD.

The configuration example 7 is a configuration example in which all of the GIMD, the DIMD, the TIMD, and the BIMD are combined, and it can be expected that the intra prediction mode with higher prediction performance can be more efficiently derived by deriving the intra prediction mode in this order for the above-described reason.

### (Start Restriction of Each Intra Prediction Mode Derivation Method)

The intra prediction unit 242 according to the present embodiment starts each derivation processing in a case where the number of intra prediction mode candidates included in the intra prediction mode candidate list has not reached a maximum value of the intra prediction mode candidate list size at the start of each derivation processing of the intra prediction modes for the geometric partition mode described above, and does not start each derivation processing when the number of intra prediction mode candidates has reached the maximum value of the intra prediction mode candidate list size.

According to such a configuration, execution of unnecessary intra prediction mode derivation processing can be avoided, and reduction of the entire processing load of the intra prediction unit 242 can be expected.

(Method for Registering Intra Prediction Mode Candidate List after Completion of Intra Prediction Mode Derivation)

The intra prediction unit 242 according to the present embodiment may be configured not to register a predetermined intra prediction mode in a case where the same prediction mode has been already included in the intra prediction mode candidate list in a case where the number of intra prediction mode candidates included in the intra prediction mode candidate list has not reached the maximum value of the intra prediction mode candidate list size at the completion of the derivation processing of the intra prediction mode for the geometric partition mode described above.

For example, in a case where the Angular prediction mode in the parallel direction to the GPM partition line has been registered, the intra prediction unit 242 may register the Angular prediction mode in the perpendicular direction to the GPM partition line as the predetermined intra prediction mode.

As a modification, for example, in a case where the Angular prediction mode in the perpendicular direction to the GPM partition line has been registered, the intra prediction unit 242 may register the Angular prediction mode in the parallel direction with respect to the GPM partition line.

Furthermore, as a modification, the intra prediction unit 242 may register, after the above-described Angular prediction mode, a Planar mode, and an intra prediction mode near the intra prediction mode initially registered in the intra prediction mode candidate list next.

### [Motion Information Derivation Method and Selection Method in Inter Prediction Unit 241]

Hereinafter, a method of deriving and selecting the motion information for the Intra/Inter-GPM and the Inter/Inter-GPM among application patterns of the intra prediction to the GPM proposed in the present embodiment in the inter prediction unit 241 will be described.

### (Method for Controlling Applicability or Inapplicability of GPM to Chroma Signal Component Block and Method for Deriving Intra Prediction Mode)

Hereinafter, a method of controlling applicability or inapplicability of the GPM to a chroma signal component block and a method of deriving the intra prediction mode by the intra prediction unit 242 in the present embodiment will be described.

In Non-Patent Literature 1, block partition (Dual Tree) in which a luminance signal component and a chroma signal component are independent is enabled only for an I slice (a slice including only an intra prediction block). The application or non-application of the Dual Tree of the block to be decoded is specified by the control data decoded by the decoding unit 210 in units of slices.

In the present embodiment, in a case where the block to be decoded is the Dual Tree, the decoding unit 210 determines that the GPM (Intra/Intra-GPM) is inapplicable to the chroma component of the block to be decoded.

Note that, in a case where the GPM (Intra/Intra-GPM) is applied to the same position (area) of the luminance component corresponding to the chroma component in the same slice, the intra prediction unit 242 derives the intra prediction mode stored at the same position (area) of the corresponding luminance component in units of 4×4 sample blocks as the intra prediction mode for the chroma component. Otherwise, the intra prediction mode included in the intra prediction block of the luminance component is derived as the intra prediction mode for the chroma component.

On the other hand, in a case where the block to be decoded is not the Dual Tree, the decoding unit 210 does not determine that the GPM (Intra/Intra-GPM) is inapplicable to the chroma component of the block to be decoded.

Here, the decoding unit 210 may determine whether to apply the GPM (Intra/Intra-GPM) to the luminance component and the chroma component according to whether to decode or estimate the common control data in units of blocks to be decoded, for example, the value of gpm_intra_enabled flag.

When it is determined that the GPM (Intra/Intra-GPM) is applied to the luminance component and the chroma component of the block to be decoded, the intra prediction unit 242 may derive the intra prediction mode used in each of the GPM partitioned areas of the luminance component block corresponding to the chroma component block as the intra prediction mode used in each of the GPM partitioned areas of the chroma component block.

### (Merge Candidate List)

In the present embodiment, the inter prediction unit 241 may derive the motion information from the merge candidate list for the GPM disclosed in Non-Patent Literature 1.

Here, the configuration disclosed in Non-Patent Literature 1 can also be applied to the present embodiment as a method of constructing a merge candidate list, and thus detailed description thereof will be omitted.

After the above-described derivation of the motion information (construction of the merge candidate list) is completed, the inter prediction unit 241 may select which motion information in the merge candidate list is to be used for generation of the inter prediction sample on the basis of the values of the two merge indexes (merge_gpm_idx0/merge_gpm_idx1) for each of the partitioned areas A/B decoded or estimated by the decoding unit 210.

Note that the decoding unit 210 may determine whether decoding of the merge index for selecting the motion information to be used in generating the inter prediction sample from the merge candidate list is necessary according to the total number of inter predictions configuring the GPM to be applied.

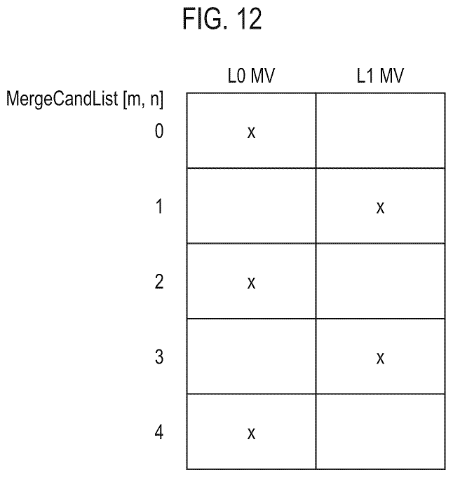

In Non-Patent Literature 1, the motion information of the inter prediction for the partitioned area A/B is derived by values of two merge indexes (merge_gpm_idx0/merge_gpm_idx1) decoded or estimated by the decoding unit 210 and a merge candidate list (MergeCandList [m, n]) for the GPM illustrated in FIG. 12.

Here, in order to prevent the pieces of motion information derived based on merge_gpm_idx0 and merge_gpm_idx1 from overlapping as much as possible, the list number from which the motion information selected by merge_gpm_idx0 and merge_gpm_idx1 is derived has a nested structure with an even number and an odd number of MergeCandList as illustrated in X of FIG. 5.

Specifically, the following m and n are calculated on the basis of merge_gpm_idx0 and merge_gpm_idx1.

$$m = merge\_gpm \_idx0 [ x C b ] [ y Cb ]$$

$$n = merge\_gpm \_idx1 [ x C b ] [ y C b ] + ( ( merge\_gpm \_idx1 [ x C b ] [ yCb ] >= m ) ? 1 : 0 )$$

Based on the value of m calculated in this manner, the motion vector, the reference frame index, and the prediction list flag configuring the motion information of the partitioned area A are derived as follows.

First, the value of X is calculated from m & 0x01 (determination of whether the value of m is an even number) and n & 0x01 (determination of whether the value of n is an even number). Here, when the calculated X is 0, the value of X is set to (1−X).

Finally, the motion vector mvA of the partitioned area A, the reference frame index refIdxA, the prediction list flag preListFlagA, the motion vector mvB of the partitioned area B, the reference frame index refIdxB, and the prediction list flag preListFlagB are derived as follows.

$$mvA = mvLXM$$

$$refIdxA = refIdxLXM$$

$$preListFlagA = X$$

$$mvB = mvLXN$$

$$refIdxB = refIdxLXN$$

$$preListFlagB = X$$

Here, M and N are numbers of merge candidates indicated by m and n in the merge candidate list, respectively, that is,

$$M = MergeCandList [ m ]$$

$$N = MergeCandList [ n ] .$$

As a modification, in the present embodiment, as an alternative to the merge candidate list for the GPM disclosed in Non-Patent Literature 1, the merge candidate list for the GPM disclosed in Non-Patent Literature 2 may be used.

Specifically, pruning processing (hereinafter, merge candidate pruning processing for the GPM) stronger than the pruning processing (hereinafter, merge candidate pruning processing for the normal merge mode) introduced in the above-described merge candidate list for the normal merge mode disclosed in Non-Patent Literature 1 is introduced.

Specifically, unlike the pruning processing for the normal merge mode disclosed in Non-Patent Literature 1, whether the motion information is to be selected as a target to be pruned is determined based on whether the reference frame included in the motion information completely matches as Non-Patent Literature 1. However, the motion vector included in the motion information is not completely matched, but is determined according to a threshold based on a block size of the block to be decoded.

Specifically, in a case where the block size to be decoded is less than 64 samples, the threshold is set to ¼ samples. In a case where the block size to be decoded is 64 samples or more and less than 256 samples, the threshold is set to ½ samples. In a case where the block size to be decoded is 256 samples or more, the threshold is set to 1 sample.

A specific flow of the merge candidate pruning processing for the GPM is similar to that of the normal merge mode pruning processing, first, whether or not the reference frames are perfectly matched is compared, and if the reference frames are perfectly matched, then whether or not the motion vectors are perfectly matched is determined.

If the reference frames do not exactly match, even if the motion vectors are below a threshold, the target is not considered to be pruned. In this case, the motion information that is not included in the merge candidate list among the comparison targets is added to the merge candidate list as a new merge candidate.

Next, in a case where the reference frames are exactly matched and the motion vector is less than the threshold, the target is considered to be pruned. In other cases, the motion information that is not in the merge candidate list among the comparison targets is added to the merge candidate list as a new merge candidate.

As a result, since the motion information in the case where the motion vectors that are not to be pruned in the pruning processing for the normal merge are similar to each other is also included in the pruning target, the similarity of the motion information derived by the two merge indexes of the GPM can be eliminated, and an improvement of the coding performance can be expected.

In the GPM pruning processing disclosed in Non-Patent Literature 2, in a case where the motion information is bi-predicted, that is, the motion information has one motion vector and one reference frame for each of L0 and L1, the motion information is regarded as a target to be pruned in a case where the motion information completely matches each of the reference frames of L0 and L1 as merge candidates to be compared.

In the present embodiment, the inter prediction unit 241 may derive the motion information by using the merge candidate list of the GPMs to which the pruning processing for the GPMs is added as an alternative for the normal merge mode.

Consequently, the motion information can be derived from the merge candidate list constructed with the motion information having the lower similarity, as a result of which the coding performance can be expected to be improved.

As a further modification, the inter prediction unit 241 may switch, by a flag, which one of the merge candidate list for the normal merge mode and the merge candidate list for the GPM is used as the merge candidate list used for deriving the motion vector.

Specifically, for example, a one-bit flag decoded by the decoding unit 210 is included in the control data, and the decoding unit 210 decodes or infers a value of the flag and transmits the value to the inter prediction unit 241, so that the switching can be performed.

Consequently, the inter prediction unit 241 can derive the motion information from more various variations, so that the prediction performance is improved, as a result of which the coding performance can be expected to be improved.

### (GPM Weighting Factor)

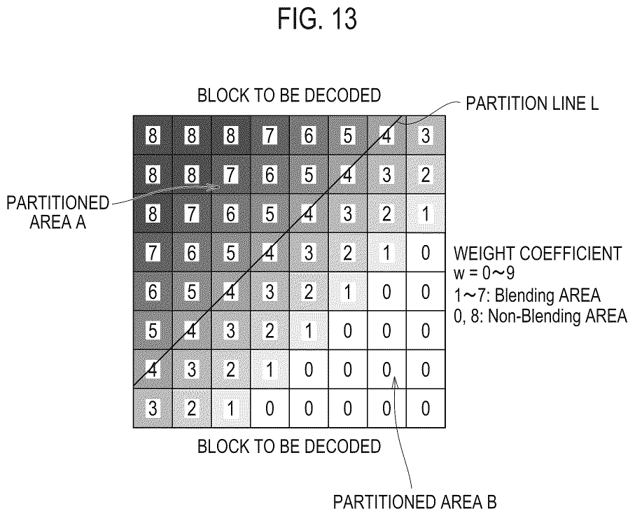

Hereinafter, the weighting coefficient w of the GPM according to Non-Patent Literature 1 and the present embodiment related to the decoding unit 210, the inter prediction unit 241, the intra prediction unit 242, and the blending unit 243 will be described with reference to FIGS. 13 to 15.

FIG. 13 is a diagram illustrating an example of a value of the weighting coefficient w for a predicted sample of each partitioned area A/B of the GPM according to Non-Patent Literature 1 and the present embodiment.

The predicted samples of the respective partitioned areas A/B generated by the inter prediction unit 241 or the intra prediction unit 242 are blended (weighted average) by the weight coefficient w in the blending unit 243.

In Non-Patent Literature 1, a value of 0 to 8 is used as the value of the weighting coefficient w, and such a value of the weighting coefficient w may also be used in the present embodiment. Here, the values 0 and 8 of the weighting coefficient w indicate a non-blending area (non-Blending area), and the values 1 to 7 of the weighting coefficient w indicate a blending area (Blending).

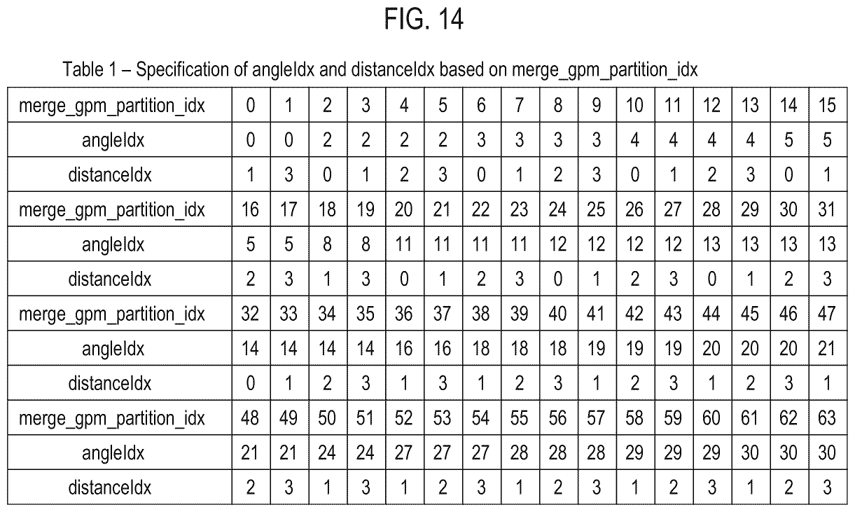

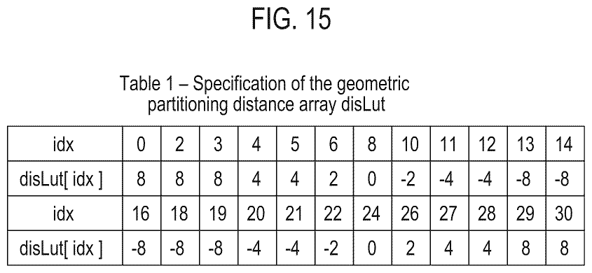

Note that, in the present embodiment, the calculation method of the weighting coefficient w can be configured to be calculated as follows from the offset value (offsetX, offsetY) calculated from the sample position (xL, yL) and the current block size, the displacement (diplacementX, diplacementY) calculated from angleIdx that defines the angle of the partition line of the geometric partitioning mode (GPM) illustrated in FIG. 14, and the table value disLut calculated from diplacementX and diplacementY illustrated in FIG. 15, by a method similar to Non-Patent Literature 1.

$$weightIdx = ( ( ( xL + offsetX ) << 1 ) + 1 ) \times disLut [ diplacementX ] + ( ( ( yL + offsetY ) << 1 ) + 1 ) \times disLut [ diplacementY ]$$

$$weightIdxL = partFlip ? 32 + weightIdx : 32 - weightIdx$$

$$w = Clip 3 ( 0 , 8 , ( weightIdxL + 4 ) >> 3 )$$

### [Prediction Information Storage Method in Inter Prediction Unit, Intra Prediction Unit, and Prediction Information Buffer]

### (Stored Motion Information Type and Stored Prediction Information Type)

Hereinafter, the stored motion information type disclosed in Non-Patent Literature 1 and the stored prediction information type according to the present embodiment in the decoding unit 210, the inter prediction unit 241, the intra prediction unit 242, and the prediction information buffer 244 will be described with reference to FIG. 161.

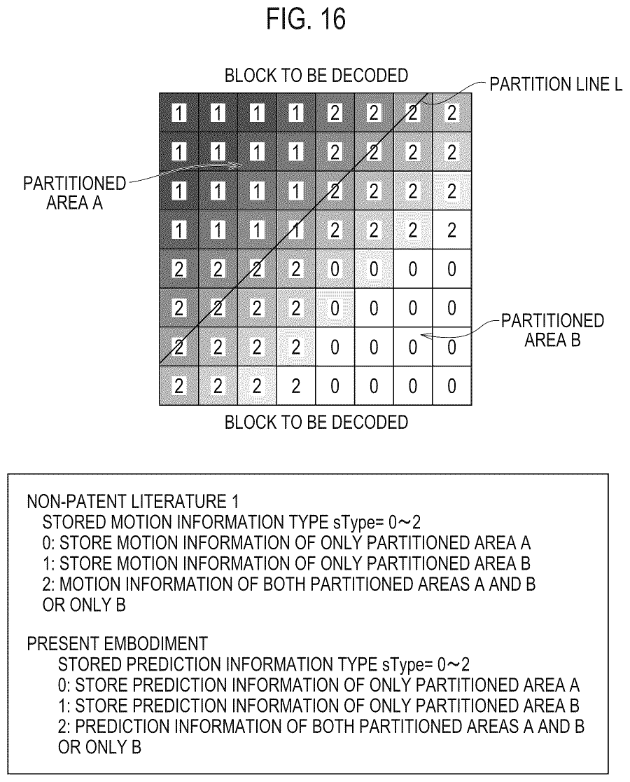

FIG. 16 is a diagram illustrating an example in which the stored prediction information type disclosed in Non-Patent Literature 1 and the stored prediction information type according to the present embodiment are specified for each 4×4 sample sub-block.

Those types are the same in the calculation methods as described below, but as illustrated in FIG. 16, are different in that the stored information is motion information in Non-Patent Literature 1, but is prediction information in the present embodiment.

First, similarly to Non-Patent Literature 1, the value of the stored motion information type and the value of the stored prediction information type (since the calculation method is the same, hereinafter, for convenience, any value is defined as sType.) are calculated as follows from an index (xSbIdx, ySbIdx) in units of 4×4 sample sub-blocks, the offset value (offsetX, offsetY) calculated similarly to the weighting coefficient w described above, the displacement (diplacementX, diplacementY), and the table (disLut).

$$motionIdx = ( ( ( 4 \times xSbIdx + offsetX ) << 1 ) + 5 ) \times disLut [ diplacementX ] + ( ( ( 4 \times ySbIdx + offsetY ) << 1 ) + 5 ) \times disLut [ diplacementY ]$$

$$sType = Abs ( motionIdx ) < 32 ? 2 : ( motionIdx <= 0 ? ( 1 - isFlip ) : isFlip )$$

Here, as illustrated in FIG. 16, the value of sType includes three types of values of 0, 1, and 2, and the motion information and the prediction information stored in the prediction information buffer 244 are controlled by the inter prediction unit 241 and the intra prediction unit 242 as follows according to the respective values.

In a case where the value of sType is 0, the motion information of the partitioned area A is stored in Non-Patent Literature 1, and the prediction information of the partitioned area A is stored in the present embodiment.

In a case where the value of sType is 1, the motion information of the partitioned area B is stored in Non-Patent Literature 1, and the prediction information of the partitioned area B is stored in the present embodiment.

In a case where the value of sType is 2, in Non-Patent Literature 1, the motion information of the partitioned area A and the partitioned area B or the motion information of only the partitioned area B is stored, and in the present embodiment, the prediction information of the partitioned area A and the partitioned area B or the prediction information of only the partitioned area B is stored.

Here, the motion information and the prediction information to be stored will be described later.

Note that the calculation unit of sType described above and the storage unit of motion information or prediction information described later may be changed from the 4×4 sample sub-block unit described above with intention of a designer.

Specifically, in order to reduce the amount of information to be stored, a unit of calculation of sType described above and a unit of storage of motion information or prediction information described later may be increased to 8×8 samples, 16×16 samples, or the like.

Alternatively, although the amount of information to be stored increases, the calculation unit of sType described above and the storage unit of motion information or prediction information described later may be reduced to 2×2 samples or the like in order to improve the accuracy of motion information or prediction information when referred from another block or frame.

### (Motion Information and Prediction Information Stored in Prediction Information Buffer)

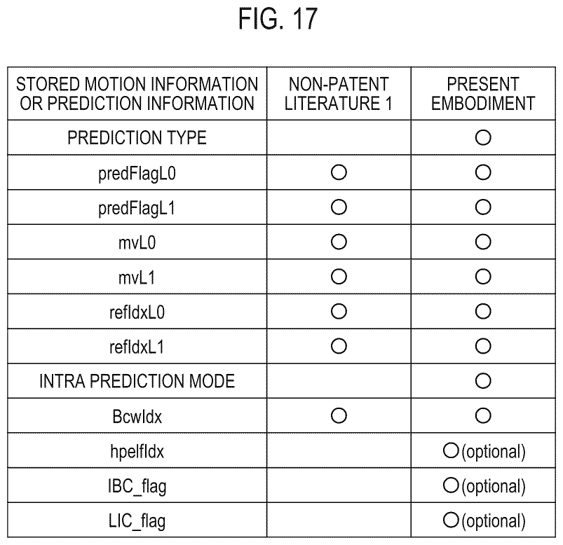

The motion information disclosed in Non-Patent Literature 1 and the prediction information according to the present embodiment, which are stored in the prediction information buffer 244 from the inter prediction unit 241 will be described below with reference to FIG. 17.

FIG. 17 is a diagram illustrating a list of the motion information disclosed in Non-Patent Literature 1 and the prediction information according to the present embodiment, which are stored according to the value of sType of the sub-block configuring the GPM-applied block.

First, the motion information finally stored in the GPM disclosed in Non-Patent Literature 1 includes the following parameters.
Prediction direction (predFlagL0, predFlagL1)
Motion vectors (mvL0, mvL1) of L0 and L1
Reference frame indexes (refIdxL0, refIdxL1) of L0 and L1
BcwIdx

Note that the prediction direction (predFlagL0, predFlagL1) is a parameter indicating a prediction direction of a sub-block stored according to sType to be described later, and is classified into three types of L0 piece prediction, L1 piece prediction, and L0/L1 binary prediction on the basis of a value of predFlagL0 and a value of predFlagL1.

Here, the L0 piece prediction is an inter prediction based on one motion vector derived from the L0 list, and a case where predFlagL0 is 1 and predFlagL1 is 0 is stored as a value indicating this condition.

In addition, the L1 piece prediction is an inter prediction based on one motion vector derived from the L1 list, and a case where predFlagL0 is 0 and predFlagL1 is 1 is stored as a value indicating this condition.

In addition, the L0/L1 bi-prediction is an inter prediction based on two motion vectors derived from each of the L0 list and the L1 list, and a case where predFlagL0 is 1 and predFlagL1 is 1 is stored as a value indicating this condition.

The motion vectors (mvL0, mvL1) of L0 and L1 are motion vectors for the list numbers L0 and L1 described above.

Further, the reference frame indexes (refIdxL0, refIdxL1) of L0 and L1 are indexes indicating reference frames referred to by mvL0 and mvL1, respectively.

In addition, BcwIdx is an index for specifying a value of a weight coefficient of BCW (Bi-prediction with CU-level weights) disclosed in Non-Patent Literature 1.

As shown in FIG. 17, the prediction type and the intra prediction mode are added to the motion information stored in the prediction information buffer 244 disclosed in Non-Patent Literature 1 as parameters to be stored as the prediction information stored in the prediction information buffer 244 in the present embodiment.

Here, the prediction type is an internal parameter indicating either inter prediction (Inter) or intra prediction (Intra) as illustrated in FIG. 17.

Furthermore, as illustrated in FIG. 17, hpeIfIdx, IBC Flag, or LIC Flag may be added as the prediction information according to the present embodiment.

Here, hpeIfIdx and IBC Flag are flags that specify whether to apply a SIF (Switchable Interpolation Filter) and an IBC (Intra Block Copy) disclosed in Non-Patent Literature 1 and a LIC (Local Illumination Compensation) disclosed in Non-Patent Literature 2, respectively.

### (Details of Prediction Information Stored According to Stored Prediction Information Type)

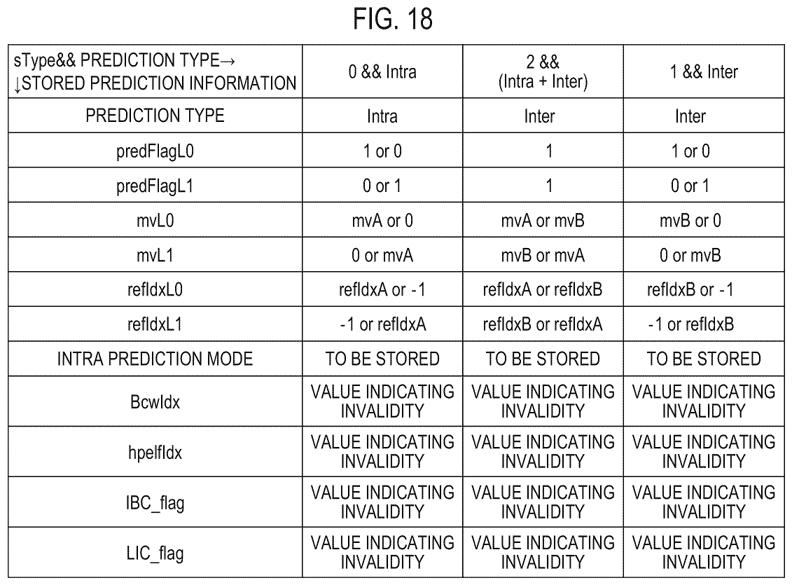

Details of the prediction information stored in the prediction information buffer 244 by the inter prediction unit 241 or the intra prediction unit 242 according to the stored prediction information type sType according to the present embodiment will be described below with reference to FIGS. 18 to 21.

FIG. 18 is a diagram illustrating an example of prediction information stored for a GPM including two different inter predictions as illustrated in FIG. 4. Hereinafter, details of each piece of prediction information saved according to the value of sType will be described.

First, that the prediction type is inter prediction (Inter) in all sType areas is stored in the prediction information buffer 244.

Second, predFlagL0, predFlagL1, mvL0, mvL1, refIdxL0, and refIdxL1 are stored as follows according to the value of sType and the values of predListFlagA and predListFlagB indicating the list number of the merge candidate list indicating the derivation destination of the motion vector of the partitioned area A/B described above, similarly to the method disclosed in Non-Patent Literature 1.

First, when sType=0, the following calculation is performed.

$$predFlagL 0 = ( predListFlagA == 0 ) ? 1 : 0$$

$$predFlagL 1 = ( predListFlagA == 0 ) ? 0 : 1$$

$$refIdxL 0 = ( predListFlagA == 0 ) ? refIdxA : - 1$$

$$refIdxL 1 = ( predListFlagA == 0 ) ? - 1 : refIdxA$$

$$mvL 0 = ( predListFlagA == 0 ) ? mvA : 0$$

$$mvL 1 = ( predListFlagA == 0 ) ? 0 : mvA$$

Next, in a case of sType=1 or in a case of sType=2 and predListFlagA+predListFlagB≠1, calculation is performed as follows.

$$predFlagL 0 = ( predListFlagB == 0 ) ? 1 : 0$$

$$predFlagL 1 = ( predListFlagB == 0 ) ? 0 : 1$$

$$refIdxL 0 = ( predListFlagB == 0 ) ? refIdxB : - 1$$

$$refIdxL 1 = ( predListFlagB == 0 ) ? - 1 : refIdxB$$

$$mvL 0 = ( predListFlagB == 0 ) ? mvB : 0$$

$$mvL 1 = ( predListFlagB == 0 ) ? 0 : mvB$$

Here, predListFlagA+predListFlagB=1 indicates a case where the list numbers of the partitioned areas A/B coincide with each other. At this time, in order to avoid duplication of motion vectors, only the motion vectors of the partitioned area B are stored even in the case of sType=2.

Next, in a case of sType=2 and predListFlagA+predListFlagB=1, calculation is performed as follows.

$$predFlagL 0 = 1$$

$$predFlagL 1 = 1$$

$$refIdxL 0 = ( predListFlag A == 0 ) ? refIdxA : refIdxB$$

$$refIdxL 1 = ( predListFlag A == 0 ) ? refIdxB : refIdxA$$

$$mvL 0 = ( predListFlagA == 0 ) ? mvA : mvB$$

$$mvL 1 = ( predListFlagA == 0 ) ? mvB : mvA$$

Here, predListFlagA+predListFlagB=1 indicates a case where the list numbers of the partitioned areas A/B do not match. At this time, the two motion vectors of the partitioned areas A/B are stored as they are.

Note that, although not illustrated in FIG. 18, the above-described mvL0 and mvL1 may store motion vectors before being corrected by Merge with Motion Vector Difference (MMVD) or Template Matching (Inter TM) for the GPM disclosed in Non-Patent Literature 2.

Alternatively, mvL0 and mvL1 described above may be motion vectors corrected by MMVD or Inter TM for GPM disclosed in Non-Patent Literature 2.

When the corrected motion vector is stored, the prediction accuracy of the prediction block that acquires the motion vector from the GPM-applied block and generates the prediction sample is improved.

On the other hand, in a case where the motion vector before correction is stored, improvement in prediction accuracy of the prediction block that refers to the motion vector from the GPM cannot be expected, but the derivation processing of the motion vector of the reference block to the GPM application block can be started without waiting for completion of the MMVD and the Inter-TM processing on the GPM block, so that a reduction in decoding processing time can be expected.

Note that which of the motion vectors before and after the correction is stored can be similarly selected for FIGS. 18 to 21 described later.

Next, the intra prediction mode may not be stored in all sType areas. Alternatively, a value indicating that intra prediction is invalid in all sType areas may be stored. This is because, in the configuration illustrated in FIG. 18, since all the areas are inter prediction, there is no intra prediction mode applied to the current block.

On the other hand, in a case where the reference destination of the motion information stored in each sType area is the intra prediction block as the intra prediction mode stored in each sType area, the intra prediction mode of the reference block may be stored as the intra prediction mode of the current block. In the case that the reference destination of the motion information stored in each sType area is the inter prediction block, the intra prediction mode of the current block may be stored as a Planar mode, or the intra prediction mode may be recursively tracked using the reference destination of the motion information stored in the inter prediction block of the reference destination. However, since there is a limit to the tracking range, if the reference destination of the intra prediction mode is not found in the case where the tracking upper limit is reached, the Planar mode may be saved as the intra prediction mode of the current block. Therefore, even if the prediction type of the predetermined area of the current block is the inter prediction, in the case where the current block is referred to from another block (for example, adjacent block) in the frame, the intra prediction can be referred to.

Next, values indicating that BcwIdx, hpeIfIdx, IBC Flag, and LIC Flag are invalid values in all sType areas may be stored. This is because all of BCW, SIF, IBC, and LIC are encoding tools exclusive to GPM, and thus it is obvious that these coding tools are invalid in the current block to which GPM is applied.

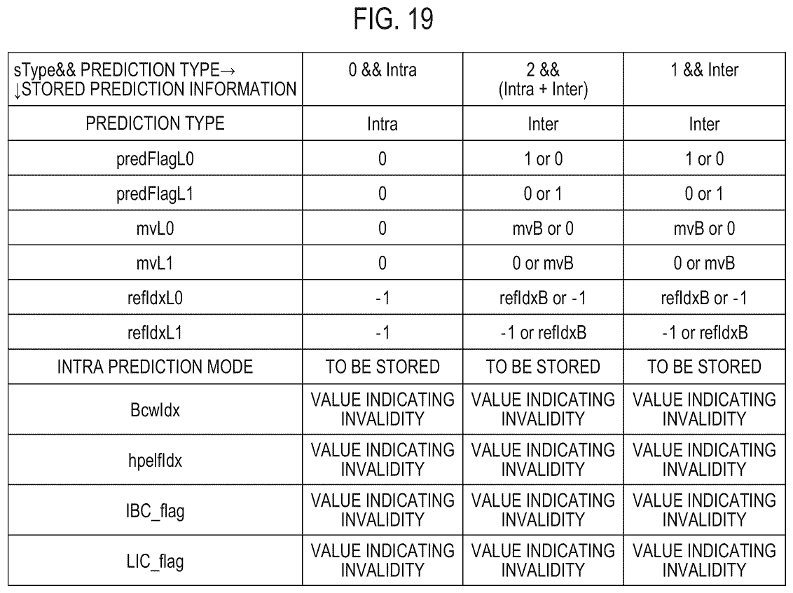

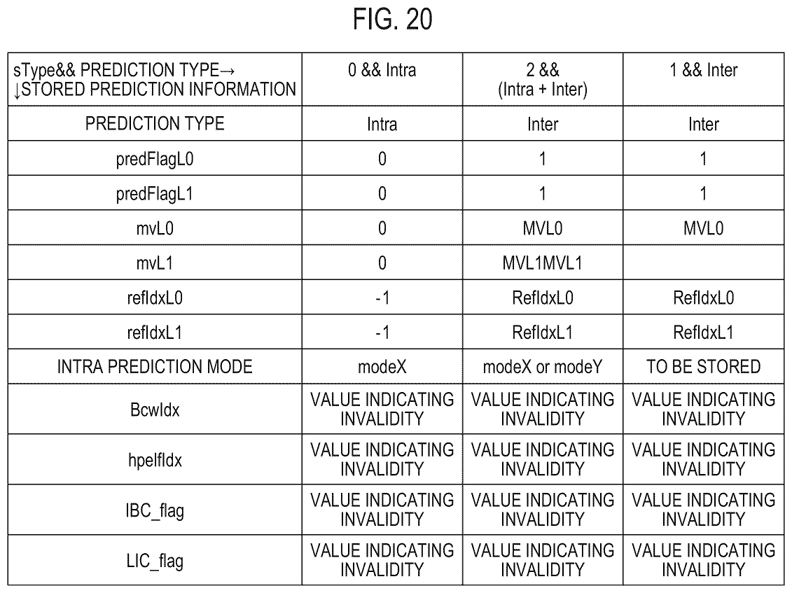

In relation, although not shown in FIGS. 18 to 20, the motion vectors used in IBC may not be stored, or 0 vectors may be stored. These parameters can have a similar configuration in FIGS. 19 and 20 to be described later, and thus the detailed description of these parameters in FIGS. 19 and 20 will be omitted below.

FIG. 19 and FIG. 20 are diagrams illustrating an example of prediction information stored for a GPM configured by intra prediction and inter prediction as illustrated in FIG. 6. Hereinafter, details of each piece of prediction information stored according to the value of sType will be described.

First, regarding the prediction information stored in the partitioned area (the partitioned area of Inter) to which the inter prediction is applied in a case of sTyper=1, in the present embodiment, the one-sided prediction is applied in a case where the current block is not included in the B slice (in a case where the current block is included in the P slice), but the bi-prediction is applied depending on the motion information of the merge candidate corresponding to the merge index as described above in a case where the current block is included in the B slice. Hereinafter, the prediction information stored in the partitioned area (the partitioned area of Inter) to which the inter prediction is applied in the case of sTyper=1 in these two cases will be described.

FIG. 19 illustrates an example of prediction information stored in a case where the current block is not included in the B slice (in a case where the current block is included in the P slice) and the one-sided prediction is applied. As illustrated in FIG. 19, the stored prediction information can have the same configuration as the configuration example of the prediction information stored in the partitioned area (the partitioned area of Inter) to which the inter prediction is applied in the case of sTyper=1 in FIG. 18.

In contrast to FIG. 19, FIG. 20 illustrates an example of prediction information stored in a case where the current block is included in the B slice and bi-prediction is applied. As illustrated in FIG. 20, the stored prediction information is different from a configuration example of the prediction information stored in the partitioned area (the partitioned area of Inter) to which the inter prediction is applied in the case of sTyper=1 in FIG. 18. Specifically, the motion vectors MVL0 and MVL1 of each of L0 and L1 and indexes RefIdxL0 and RefIdxL1 indicating the reference frames of each of L0 and L1 are stored from the motion information included in the merge candidate corresponding to one merge index with respect to the partitioned area.

Note that, also in the case of FIG. 20, the intra prediction mode among the stored prediction information may have the same configuration as the configuration example of the prediction information stored in the partitioned area (the partitioned area of Inter) to which the inter prediction is applied in the case of sTyper=1 in FIG. 18.

Secondly, the prediction information stored in the partitioned area (Intra partitioned area) to which intra prediction is applied when sTyper=0 is stored as follows as illustrated in FIG. 19 and FIG. 20.
Prediction type=Intra
predFlag0=0
predFlag1=0
mvL0=0
mvL1=0
refIdxL0=−1
refIdxL1=−1
intra prediction mode=modeX

Here, since intra prediction is applied to such a partitioned area, Intra is stored as the prediction type, and modeX is stored as the intra prediction mode, as described above.

Note that, as a modified example, for example, as in Non-Patent Literature 1, in a case where only an coding tool that refers only to the intra prediction type in units of sub-blocks from the neighbor and does not refer to the intra prediction mode is included, a configuration may be employed in which the intra prediction mode is not saved while Intra is saved as the prediction type.

As a further modification, even in a case where the intra prediction mode is applied to the GPM, none of the applied intra prediction modes may be configured to be stored.

On the other hand, since there is no motion information, as described above, 0 may be stored as predFlag0 and predFlagL1, 0 (meaning a 0 vector) may be stored as mvL0 and mvL1, and −1 (meaning that there is no reference frame) may be stored as refIdxL0 and refIdxL1.

Alternatively, as a modification, in order to avoid a tight capacity of the buffer area of the prediction information buffer 244, the motion information may not be stored.

Third, the prediction information stored in the partitioned area (the partitioned area of Intra+Inter) to which the intra prediction and the inter prediction are applied in the case of sTyper=2 differs as illustrated in FIGS. 14 and 15 depending on the configuration of the prediction information stored in sTyper=1 described above.

In the case illustrated in FIG. 19, the prediction information is stored as follows.

Prediction type=Inter

predFlag0=(predListFlagB==0)?1:0

predFlag1=(predListFlagB==0)?0:1

refIdxL0=(predListFlagB==0)?refIdxB:−1

refIdxL1=(predListFlagB==0)?−1:refIdxB

mvL0=(predListFlagB==0)?mvB:0

mvL1=(predListFlagB==0)?0:mvB

intra prediction mode=modeX

On the other hand, in the case illustrated in FIG. 15, the prediction information is stored as follows.

Prediction type=Inter

predFlag0=1

predFlag1=1

refIdxL0=RefIdxL0

refIdxL1=RefIdxL1

mvL0=MVL0

mvL1=MVL1

intra prediction mode=modeX

Here, since the intra prediction of sType=1 is applied in such a partitioned area, the same parameters as those stored in sType=1 are stored as the prediction type and the intra prediction mode among the prediction information as described above. When there are two types of intra prediction modes that can be stored in the future, an intra prediction mode of sType=0 may be additionally stored in the partitioned area.

Furthermore, in such a partitioned area, since the inter prediction of sType=2 is applied, the same parameters as those stored with sType=2 are stored as the parameters related to the motion field information among the prediction information as described above.

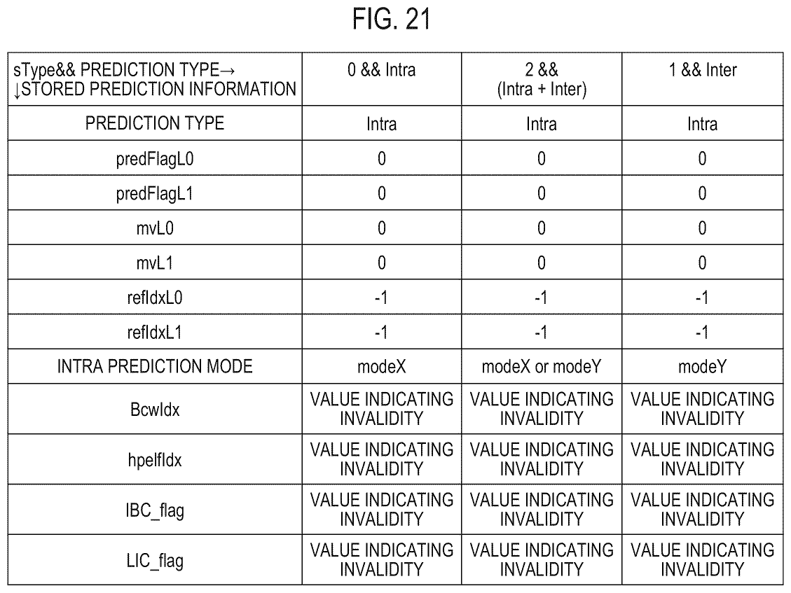

FIG. 21 is a diagram illustrating an example of prediction information stored for a GPM including two different intra predictions as illustrated in FIG. 7. Hereinafter, details of each piece of prediction information saved according to the value of sType will be described.

Firstly, among the prediction information stored in all the sType areas, the parameters other than the intra prediction mode can have the same configuration as the parameters stored in the Intra partitioned area in the case of sType=0 described in FIG. 14, and thus the description thereof will be omitted.

Secondly, as the intra prediction modes of the area of sType=0 and the area of sType=1, as illustrated in FIG. 20, two different intra prediction modes modeX and modeY applied in each area are stored.

Third, in the area of sType=2, as illustrated in FIG. 20, both the intra prediction modes of the area of sType=0 and the area of sType=1 may be stored, or any one of the intra prediction modes may be stored.

For the former, for example, in a case where two intra prediction modes can be used in the image encoding device 100 and the image decoding device 200, two intra prediction modes may be stored.

For the latter, for example, the intra prediction mode of sType=0 may be selected as the intra prediction mode of sType=2 by decision.

Alternatively, for example, from which intra prediction mode the 4×4 sample sub-block is dominantly generated may be calculated, for example, in units of 2×2 sample sub-blocks obtained by further subpartitioning the 4×4 sample sub-block, and the dominant intra prediction mode may be selected as the intra prediction mode of the area of sType=2.

Alternatively, a smaller distance between the sub-block and the adjacent reference sample existing in the direction indicated by the two intra prediction modes of the sub-block may be selected as the intra prediction mode of sType=2.

As a further modification, as illustrated in FIG. 21, even in a case where two intra prediction modes are applied to two GPMs, neither of the two applied intra prediction modes may be stored.

With use of the prediction information and the method for storing the prediction information described above, it is possible to appropriately refer to the prediction information in a case where the intra prediction is added to the GPM from the inside of the frame or the outside of the frame, as a result of which improvement of the coding performance can be expected.

Note that, among the prediction information stored in the prediction information buffer 244 described above, parameters other than the intra prediction mode may be deleted from the prediction information buffer 244 in a case where the parameters are no longer referred to from inside or outside the frame.

In addition, when a storage area for the parameter is secured in the prediction information buffer 244, the storage area may be initialized. Here, timing at which reference from the outside of the frame is stopped is the same as the timing at which the frame including the GPM applied block is deleted from the frame buffer 260 (frame buffer 160).

Further, among the prediction information stored in the prediction information buffer 244, the intra prediction mode may be deleted from the prediction information buffer 244 when the intra prediction mode is no longer referred to from the frame. Furthermore, in a case where a storage area corresponding to the intra prediction mode is secured in the prediction information buffer 244, the storage area may be initialized.

Note that, in the above description, the signaling method at the time of applying the intra prediction mode to the GPM in that case has been described with reference to the case where the rectangular block is partitioned into two parts by the GPM. However, the signaling method described in the present embodiment can be applied to a case where the rectangular block is partitioned into three or more parts by the GPM in a similar concept.

Further, the image encoding device 100 and the image decoding device 200 may be realized as a program causing a computer to execute each function (each step).

Note that the above described embodiments have been described by taking application of the present invention to the point cloud encoding device 10 and the point cloud decoding device 30 as examples. However, the present invention is not limited only thereto, but can be similarly applied to an encoding/decoding system having functions of the encoding device 10 and the decoding device 30.

According to the present embodiment, it is possible to improve the overall quality of service in video communications, thereby contributing to Goal 9 of the UN-led Sustainable Development Goals (SDGs) which is to “build resilient infrastructure, promote inclusive and sustainable industrialization and foster innovation”.

What is claimed is:

1. An image decoding device including a circuit, wherein
the circuit:
derives motion information for a geometric partitioning mode to generate a motion compensation sample; and
derives an intra prediction mode for the geometric partitioning mode to generate an intra prediction sample,
the circuit:
derives a plurality of the intra prediction modes on the basis of adjacent reference samples or adjacent reference blocks adjacent to the block to be decoded, and
selects, with use of a signaled index, one or a plurality of intra prediction modes from an intra prediction mode candidate list including the plurality of derived intra prediction modes to generate the intra prediction sample.

2. An image decoding method comprising:
deriving motion information for a geometric partitioning mode to generate a motion compensation sample;
deriving an intra prediction mode for the geometric partitioning mode to generate an intra prediction sample, wherein
the deriving of the intra prediction mode comprising:
deriving a plurality of the intra prediction modes on the basis of adjacent reference samples or adjacent reference blocks adjacent to the block to be decoded, and
selecting, with use of a signaled index, one or a plurality of intra prediction modes from an intra prediction mode candidate list including the plurality of derived intra prediction modes to generate the intra prediction sample.

3. A program stored on a non-transitory computer-readable medium for causing a computer to function as an image decoding device comprising a circuit:
the circuit:
derives motion information for a geometric partitioning mode to generate a motion compensation sample; and
derives an intra prediction mode for the geometric partitioning mode to generate an intra prediction sample,
the circuit:
derives a plurality of the intra prediction modes on the basis of adjacent reference samples or adjacent reference blocks adjacent to the block to be decoded, and
selects, with use of a signaled index, one or a plurality of intra prediction modes from an intra prediction mode candidate list including the plurality of derived intra prediction modes to generate the intra prediction sample.
